(19) United States
(12) Patent Application Publication
(10) Pub. No.: US 2011/0296476 A1
(43) Pub. Date: Dec. 1, 2011

(54) SYSTEMS AND METHODS FOR PROVIDING A SOCIAL MASHUP IN A CONTENT PROVIDER ENVIRONMENT

(76) Inventors: Alan Rouse, Lawrenceville, GA (US); Charles Dasher, Lawrenceville, GA (US)

(21) Appl. No.: 12/787,471

(22) Filed: May 26, 2010

(51) Int. Cl. H04N 7/173

(52) U.S. Cl. 725/109

(57) ABSTRACT

Various embodiments of the present invention provide systems and methods for providing a social mashup in a content provider environment. In particular embodiments, the systems and methods provide a mashup that may be published for viewing by a plurality of subscribers of the content provider and may allow for content to be posted by various subscribers.

### BACKGROUND OF THE INVENTION

1. Field of the Invention

The disclosed invention generally relates to systems and methods for providing a social mashup in a content provider environment, and more specifically, to systems and methods for providing a mashup that may be published for viewing by a plurality of subscribers of the content provider and may allow for content to be posted by various subscribers.

2. Description of the Related Art

Today, many cable service and satellite TV providers offer a wide range of products and services to their subscribers. For instance, one such service is video on demand (VOD) programming or audio video on demand (AVOD) that allow subscribers to select and watch/listen to video and/or audio content on demand. In addition, providers of Web content offer a wide range of products and services to Internet users. However, in many instances, an individual is required to access these products and services via separate mechanisms. That is, an individual is required to access a cable service provider's products and services through the cable provider's system using a set-top box and the individual is required to access a Web content provider's products and services over the Internet through the individual's computer.

Social networks are becoming increasingly popular. One such social networking tool is a mashup. A mashup is a software application that combines data or functionality from two or more sources into a single integrated application. Typically, a mashup is provided via a Web application and a user of the mashup will access the mashup through a Web page. However, it is desirable to be able to access such a tool through a cable service provider's and satellite TV provider's system. This would allow a subscriber to access Web content of interest to the subscriber without the subscriber having to leave the cable service provider's or satellite TV provider's system, such as, for instance, allowing a subscriber to access Web content by using a service provider's VOD service.

Further, it is desirable to allow subscribers of a service provider, acting as a publisher, to be able to publish mashups configured and managed by them so that other subscribers may view the mashups through the service provider's system. In addition, subscribers viewing the mashups may want to post content on the mashup for viewing by other subscribers. For instance, a subscriber may read a particular article published on a mashup and may wish to post a comment (e.g., message) about the article for other subscribers to read and to invite other subscribers to post further comments. Thus, it is desirable to enable published mashups within the service provider's system to allow for subscribers to provide additional content to be posted on the mashups. Such capabilities provide a social networking tool within a service provider's system.

### BRIEF SUMMARY OF THE INVENTION

Various embodiments of the present invention provide a system for providing a mashup in a cable distribution system. In particular embodiments, the cable distribution system includes a cable distribution network and one or more servers in communication with the cable distribution network and configured to receive a configuration for the mashup. In various embodiments, the configuration includes a unique identifier identifying the mashup, a first display area associated with a data source, and a second display area identified for displaying text messages. Further, the one or more servers are configured to store the configuration in memory and to obtain content from the data source.

In various embodiments, the one or more servers are further configured to receive a first request entered by a first subscriber for the mashup over the cable distribution network from a first set-top box. In response to receiving the first request, the one or more servers are configured to obtain the configuration from the memory using the unique identifier and generate first MPEG data, the first MPEG data representing at least a portion of the content displayed in the first display area. Further, the one or more servers are configured to transmit the first MPEG data in a MPEG stream over the cable distribution network to the first set-top box. In response, the first set-top box generates signals from the first MPEG data to display the mashup with the portion of the content displayed in the first display area.

In addition, the one or more servers are configured in various embodiments to receive a first text message originating from the first subscriber. In response to receiving the first text message, the one or more servers are configured to generate second MPEG data, the second MPEG data representing the portion of the content displayed in the first display area and at least a portion of the first text message displayed in the second display area, and to transmit the second MPEG data in the MPEG stream over the cable distribution network to the first set-top box. In response, the first set-top box generates signals from the second MPEG data to display the mashup with the portion of the content displayed in the first display area and the portion of the first text message displayed in the second display area. In particular embodiments, the one or more servers receive the first text message from the first set-top box. In other embodiments, the one or more servers receive the first text message over a communication channel from a mobile device. In other embodiments, the one or more servers receive the first text message over a second network from a computer.

Further, in particular embodiments, the one or more servers are configured to transmit the second MPEG data in a second MPEG stream over the cable distribution network to a second set-top box for a second subscriber in response to receiving a second request from the second subscriber for the mashup. In turn, the second set-top box generates signals from the second MPEG data to display the mashup with the portion of the content displayed in the first display area and the portion of the first text message displayed in the second display area.

In particular embodiments, in response to receiving a second text message originating from the second subscriber, the one or more servers are configured to generate third MPEG data, the third MPEG data representing the portion of the content displayed in the first display area and at least a portion of the first text message and at least a portion of the second text message displayed in the second display area, and to transmit the third MPEG data in the MPEG stream and the second MPEG stream over the cable distribution network to the first and second set-top boxes, respectively. In turn, the first and second set-top boxes generate signals from the third MPEG data to display the mashup with the portion of the content displayed in the first display area and the portion of the first text message and the portion of the second text message displayed in the second display area.

Various embodiments of the previous invention provide a system for providing a mashup in a cable distribution system including a cable distribution network and one or more servers in communication with the cable distribution network. In these particular embodiments, the one or more servers are configured to receive a configuration for the mashup that includes a unique identifier identifying the mashup, a first display area associated with a data source, and a second display area identified for displaying content. Further, in these particular embodiments, the one or more servers are configured to receive a first request entered by a first subscriber for the mashup from a first set-top box, and in response to receiving the first request, the one or more servers are configured to obtain the configuration, generate first MPEG data, the first MPEG data representing at least a portion of the first content displayed in the first display area, and transmit the first MPEG data in a MPEG stream to the first set-top box. In response, the first set-top box generates signals from the first MPEG data to display the mashup with the portion of the first content displayed in the first display area.

Further, in particular embodiments, the one or more servers are configured to receive a content identifier originating from the first subscriber and identifying a location of a second content and to retrieve the second content from the location using the content identifier. In these particular embodiments, the one or more servers are configured to generate second MPEG data representing the portion of the first content displayed in the first display area and at least a portion of the second content displayed in the second display area and to transmit the second MPEG data in the MPEG stream over the cable distribution network to the first set-top box. In response, the first set-top box generates signals from the second MPEG data to display the mashup with the portion of the first content displayed in the first display area and the portion of the second content displayed in the second display area. In addition, in particular embodiments, the one or more servers are configured to transmit the second MPEG data in a second MPEG stream over the cable distribution network to a second set-top box of a second subscriber in response to receiving a second request from the second subscriber for the mashup. In response, the second set-top box generates signals from the second MPEG data to display the mashup with the portion of the first content displayed in the first display area and the portion of the second content displayed in the second display area. In various embodiments, the second content may be a video, an image, or audio.

In addition, further embodiments of the present invention provide a method for providing a mashup in a cable distribution system. In these particular embodiments, the method includes the step of receiving a configuration for the mashup. The configuration includes a unique identifier identifying the mashup, a first display area associated with a data source, and a second display area identified for displaying text messages. The method further includes the steps of storing the configuration in memory, obtaining content from the data source, and receiving a first request entered by a first subscriber for the mashup over a cable distribution network from a first set-top box. In response to receiving the first request, the method includes the steps of obtaining the configuration from the memory by using the unique identifier, generating first MPEG data, the first MPEG data representing at least a portion of the content displayed in the first display area, and transmitting the first MPEG data in a MPEG stream over the cable distribution network to the first set-top box, wherein the first set-top box generates signals from the first MPEG data to display the mashup with the portion of the content displayed in the first display area.

Further, in these particular embodiments, the method includes the steps of receiving a first text message originating from the first subscriber, and in response to receiving the first text message, generating second MPEG data, the second MPEG data representing the portion of the content displayed in the first display area and at least a portion of the first text message displayed in the second display area, and transmitting the second MPEG data in the MPEG stream over the cable distribution network to the first set-top box. In turn, the first set-top box generates signals from the second MPEG data to display the mashup with the portion of the content displayed in the first display area and the portion of the first text message displayed in the second display area.

Finally, various embodiments of the present invention provide a method for providing a mashup in a cable distribution system that includes the step of receiving a configuration for the mashup, in which the configuration includes a unique identifier identifying the mashup, a first display area associated with a data source, and a second display area identified for displaying content. In these particular embodiments, the method further includes the step of receiving a first request entered by a first subscriber for the mashup over the cable distribution network from a first set-top box. In response to receiving the first request, the method includes the steps of obtaining the configuration using the unique identifier, generating first MPEG data, the first MPEG data representing at least a portion of the first content displayed in the first display area, and transmitting the first MPEG data in a MPEG stream over the cable distribution network to the first set-top box. In response, the first set-top box generates signals from the first MPEG data to display the mashup with the portion of the first content displayed in the first display area.

Further, in these particular embodiments, the method includes the steps of receiving a content identifier originating from the first subscriber identifying the location of a second content, and in response to receiving the content identifier, retrieving the second content from the location using the content identifier, generating second MPEG data, the second MPEG data representing the portion of the first content displayed in the first display area and at least a portion of the second content displayed in the second display area, and transmitting the second MPEG data in the MPEG stream over the cable distribution network to the first set-top box. In response, the first set-top box generates signals from the second MPEG data to display the mashup with the portion of the first content displayed in the first display area and the portion of the second content displayed in the second display area.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a flow diagram illustrating the process for providing a social mashup according to various embodiments of the invention.

FIG. 2 is a schematic diagram illustrating a system architecture supporting social mashups according to various embodiments of the invention.

FIG. 3 is a schematic diagram illustrating a mashup management server according to various embodiments of the invention.

FIG. 4 is a schematic diagram illustrating a set-top box according to various embodiments of the invention.

FIG. 5 is a flow diagram of a configuration tool module according to various embodiments of the invention.

FIG. 6 is a flow diagram of a mashup module according to various embodiments of the invention.

FIG. 7 is a flow diagram of a set-top box module according to various embodiments of the invention.

FIG. 8 is an example of a social mashup screen according to various embodiments of the invention.

FIG. 9 is an example of additional content for an item on a mashup according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### Brief Overview of an Embodiment

Various embodiments of the present invention provide systems and methods for configuring, managing, and providing a social mashup in a content provider environment, such as a cable service provider and/or satellite TV provider. The term “mashup” is used from this point forward to comprise a display of combined content from various sources in a defined configuration. The term “social” is used to indicate that a particular mashup may be made available to more than one subscriber of the content provider. As is described in further detail below, in various embodiments, the mashup may be provided to a limited number of subscribers (e.g., community groups) or may be provided to all subscribers of the content provider (e.g., “general public”). Further, the term “social” is used to indicate that content may be “posted” on the mashups by various subscribers. For instance, in various embodiments, subscribers may post text messages, video content, images, and/or audio content on the mashups. Particular content to be displayed on the mashups may be associated with a particular data source. For instance, content may be the local news headlines found on a particular website or may be a text message provided by a subscriber viewing the mashup. Thus, a “data source” is the source used to provide content. For instance, a data source may be a Web page, a document embedded in a Web page, a document, image, video, or audio stored in local or remote memory. In addition, a data source may be identified and/or provided by a subscriber viewing the mashup. Furthermore, the term “provider” is used from this point forward to indicate a cable service provider or a satellite TV provider or any other provider of distributed media content. In many instances, a service provider system is considered a “closed” system because generally an individual must be a subscriber of the servicer provider in order to gain access to the service provider's system. For example, an individual subscribes with a cable service provider so that the individual can receive cable service from the provider over the cable service provider's distribution network. However, a subscriber in the context of this disclosure may also include an individual or an entity that is providing content and/or a mashup in the content service provider's system. For example, an entity, such as the Coca Cola® Corporation, may wish to provide a mashup in the cable service provider's system and may pay the cable service provider a monthly fee to have the mashup available in the cable service provider's system. In another example, an entity may provide advertising (e.g., content) to post on mashups within the cable service provider's system.

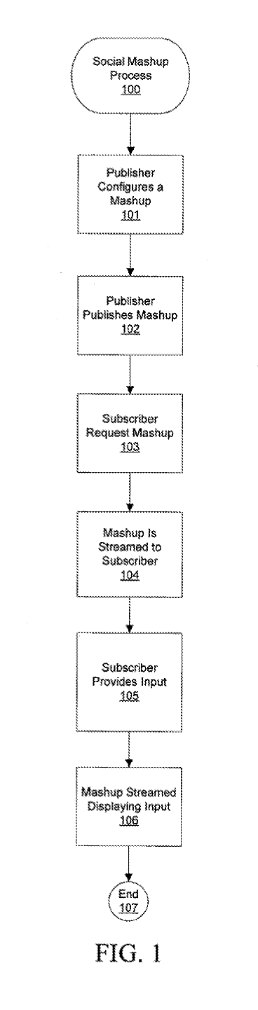

FIG. 1 illustrates one embodiment of a flow diagram of a process 100 for providing a social mashup. In various embodiments, a first subscriber (e.g., publisher) of a provider may wish to configure and post a mashup in the provider's distribution system. A publisher is an individual and/or entity that configures a mashup, manages the mashup, and publishes the mashup so that subscribers may view and interact with the mashup. For instance, in one embodiment, the publisher may be a fan of reality television programs and may wish to publish a mashup within the provider's system that includes content directed to various reality television programs.

As is described in greater detail below, in various embodiments, the publisher configures the mashup and specifies what content to include in the mashup, shown as Step 101. For instance, the publisher may select from one or more mashup templates and may indicate content (e.g., indicate data sources) to include and in what format to include the content on the template (e.g., indicate one or more “widgets”). For example, the publisher may indicate to include content from a website about the television program “The Biggest Loser”® on the top right corner of the mashup, content from past “The Biggest Loser”® shows stored in the provider's asset library on the top left corner of the mashup, and a widget on the bottom half of the mashup that allows subscribers to post messages on the mashup.

A “widget” is generally an object placed on a mashup that may display content (e.g., provides a format for displaying content) and/or may invite a subscriber to act in a number of ways (e.g., may provide an interactive function on the mashup). For instance, in various embodiments, a number of widgets may be made available for a publisher configuring a mashup to use, such as boxes for displaying text, graphics, video, or audio, buttons, pull-down menus, icons, scroll bars, menu bars, and toggle switches. Thus, a publisher configuring a mashup may use a widget, such as a button or pull-down menu, to solicit input from subscribers viewing the mashup. These widgets may be provided by different mechanisms according to various embodiments. For instance, in one embodiment, the widgets are provided through such technology as enhanced TV binary interchange format (EBIF).

Further, the publisher may indicate what source to use to obtain the content for each entry (e.g., widget) on the mashup. For instance, in one embodiment, the publisher may enter or select a uniform resource locator (URL) that is used to locate particular content for a widget. While in another embodiment, the URL may be tied to a particular widget and the source for the content is automatically identified when the publisher selects the particular widget. Thus, once the publisher has finished selecting the different widgets to include on the subscriber's mashup, the mashup configuration is saved. This configuration may be saved in some sort of storage medium such as a central location in the provider's system. Further, in various embodiments, the widgets on a publisher's mashup may not all be publisher defined. For instance, in various embodiments, the cable provider may include widgets on the publisher's mashup for advertising purposes.

In Step 102, once the publisher has configured the mashup, the publisher may publish the mashup to make it available in the service provider's system. For instance, in one embodiment, the publisher may post the mashup on a list of available mashups to all of the subscribers of the service provider. Thus, any subscriber on the service provider's system may access the list and select the mashup from the list of available mashups. In particular embodiments, the list of available mashups may be provided as a menu option in the service provider's video-on-demand (VOD) service. In other embodiments, the list of available mashups may be provided via a stand-along application that resides on subscribers' set-top boxes. In other embodiments, the publisher may identify subscribers that may have access to the mashup. As is provided in further detail below, in various embodiments, community groups may be defined within the service provider's system and may include certain subscribers. Thus, the publisher may identify one or more of these community groups as being able to access the mashup for viewing. While in other embodiments, the publisher may simply identify individual subscribers as being able to access the mashup for viewing.

Therefore, a subscriber may be watching a particular program and decide that he would like to view a mashup. In this particular embodiment, the subscriber selects the provider's VOD service, maneuvers through one or more screens, and selects a button on the subscriber's remote control signaling the set-top box to display a list of available mashups. The subscriber scrolls through the list of available mashups and selects the mashup published by the publisher, shown as Step 103. The set-top box receives the command and sends the request to the provider's mashup management system. In various embodiments, the provider's mashup management system may be centrally located and may service one or more headends of the provider. Thus, the set-top box sends the request over the provider's distribution network to the headend and the headend directs the request to the mashup management system. In other embodiments, the mashup management system may be located within a particular headend.

In various embodiments, the mashup management system determines which mashup has been requested by the subscriber and retrieves the mashup's configuration (e.g., the mashup's configuration data). In various embodiments, the system reads the configuration and obtains the content for applicable widgets defined in the configuration by utilizing the URLs associated with the widgets. For example, the user may have selected a widget (e.g., text box) for displaying information from a particular website associated with the television program “The Biggest Loser”®. Thus, in this particular embodiment, the mashup management system is in communication with the Internet and obtains the information over the Internet by visiting the website associated with the URL. In another embodiment, the mashup management system may periodically poll the website for content and store the content locally. Thus, in this particular embodiment, the mashup management system obtains the content for the particular widget from the locally stored content without having to access the website over the Internet. In particular instances, this may be more efficient than accessing the Internet each time for content that is posted on a number of mashups because the system may be able to retrieve the content more quickly. Therefore, in various embodiments, the mashup management system may obtain content both from the Internet and locally.

In addition, in various embodiments, the mashup management system may subscribe to RSS/Atom newsfeeds or other content update announcement schemes. Thus, in these particular embodiments, when the content source is updated, the mashup management system is notified and the system immediately pulls the content into local memory. Therefore, if multiple mashups make use of the content, the system can use a single copy for all of the mashups. Furthermore, in various embodiments, the system can alert subscribers of a particular mashup once a notification is received via a ticker optionally displayed along with the programming the subscribers are currently watching. Other sources of content may include content created by subscribers, such as content entered using a remote control, content stored on a website and/or in a VOD system, and/or content from a cell phone service or Twitter® (such as text messages). Some of such content sources are detailed in U.S. patent application Ser. No. 12/347,430 filed on Dec. 31, 2008 and entitled “Systems, Methods, and Apparatus for Tagging Segments of Media Content,” and U.S. patent application Ser. No. 12/494,425 file on Jun. 30, 2009 and entitled “Systems and Methods for Incorporating User Generated Content Within a VOD Environment,” which are both incorporated herein by reference in their entirety.

In various embodiments, the mashup management system renders a first portion (e.g., a subset of content) for each applicable widget into a compatible format (e.g., one or more MPEG files). In various embodiments, these first portions are the content initially shown for each applicable widget on the mashup. For instance, in one embodiment, the mashup management system calls a transcoder or transcoding system to transcode the portions of content into a format compatible with the provider's VOD system. For example, such formats may include CableLabs® MPEG2 Transport SD, CableLabs® MPEG2 Transport HD, H.264 Transport SD with MPEG audio or AAC audio, H.264 Transport HD with AAC audio, and/or H.264 web format with AAC audio.

In Step 104, the mashup management system inserts (e.g., multiplexes) the MPEG files into a MPEG stream that is sent to the subscriber's set-top box. In many instances, since the stream is intended for a particular subscriber, the headend directs the MPEG files over a unicast stream to the subscriber's set-top box. Thus, in various embodiments, the headend may transmit data to the subscriber's set-top box identifying a particular stream and may transmit the MPEG files over the stream to the subscriber's set-top box. In turn, the set-top box tunes to the channel carrying the stream as identified in the data. In other embodiments, the headend may combine the MPEG files along with the current programming to be streamed to the subscriber's set-top box into a combined stream. Thus, in various embodiments, the combined stream is a distinct stream that comprises the stream that includes the MPEG Files for the mashup and the stream that includes the current programming. Therefore, the set-top box receives the stream and displays the portion of the content for each applicable widget as configured on the template. In particular embodiments that utilize the combined stream, the portion of the content for each applicable widget may visually appear to be superimposed over the current programming on the subscriber's television screen.

Thus, in various embodiments, the MPEG files are provided like any other type of content that is multiplexed into the MPEG stream sent to the set-top box and the set-top box simply displays the files as received. For instance, the mashup management system may utilize a system to construct the one or more MPEG frames, such as I-frames, to represent the mashup and may stream the MPEG frames to the subscriber's set-top box. Such a system is detailed in U.S. patent application Ser. No. 12/406,493 filed on Mar. 18, 2009 and entitled “Systems and Methods for Providing a Dynamic User Interface for a Settop Box,” which is incorporated herein by reference in its entirety.

Continuing with the process 100, the publisher's mashup is displayed on the subscriber's television. The subscriber may read the portions of content on the mashup. As mentioned, in particular embodiments, the mashup may include one or more widgets that allow the subscriber to interact with the mashup. For instance, in one embodiment, the mashup may include a text box that is configured to receive text messages entered by the subscriber using a device in communication with the set-top box such as the subscriber's remote control. Thus, in this particular instance, the subscriber may wish to post a text message in the text box. The subscriber selects the text box on the mashup and enters a text message using his remote control, shown as Step 105. Once the subscriber has finished entering the message, he selects a button on the remote control to post the message.

In response, the subscriber's set-top box directs the message over the provider's distribution network to the mashup management system. The text message routed to the mashup management system may include other information. For example, the text message may be routed along with an identifier for the mashup and an identifier for the subscriber and/or set-top box. Therefore, the system receives the text message and information and re-configures the MPEG files for the mashup to include the text message in the text box. Further, the subscriber may be identified on the mashup as supplying the text message.

In Step 106, the mashup management system streams the MPEG files over the provider's distribution network to the subscriber's set-top box. In response, the set-top box displays the mashup to the subscriber with the subscriber's text message displayed in the text box on the mashup.

In various embodiments, one or more other subscribers may also be viewing the publisher's mashup at the time the subscriber enters the text message. Therefore, as a result, the mashup management system also streams the re-configured MPEG files over the provider's distribution network to the set-top boxes for these subscribers. Accordingly, the set-top boxes display the mashup to the subscribers with the subscriber's text message displayed in the text box on the mashup. In turn, these subscribers may enter additional text messages to display in the text box for all subscribers to read who are viewing the publisher's mashup. Thus, the text box displayed on the mashup provides the subscribers with an interactive component that allows the subscribers to communicate with each other.

Further, in various embodiments, the mashup management system is configured to save the text messages entered by the various subscribers (for a predetermined period of time). Therefore, a subscriber who requests the publisher's mashup at a later time after the text messages have been posted is still able to view the text messages entered by the various subscribers. As a result, various subscribers of the service provider are provided with a mashup through the provider's system that is made up of content of particular interest to the subscribers and that allows the subscribers to interact with the mashup and each other by posting further content on the mashup.

### Community Groups

As previously mentioned, a publisher (e.g., subscriber) can post a mashup and have the mashup available for viewing (and/or for adding content) to one or more community groups (“CGs”). These community groups may include one or more subscribers of the service provider (e.g., members). In various embodiments, at least four different types of CGs classifications are provided. However, it should be noted that the classification of the groups is provided for illustrative purposes only, and should not be viewed as limiting particular embodiments to having a certain number or type of community groups. Thus, other classifications are possible and the classifications described are only exemplary.

A “Sponsored” CG is a community group that is typically operated by an organization or business. In many instances, these groups focus around a particular interest such as a college football CG sponsored by the college's alumni organization or a public service group sponsored by a city or a public school or school booster organization. In various embodiments, the Sponsored CG is administered by an entity (or more specifically, an individual associated with the entity), as opposed to an individual representing his own interest. Furthermore, the name of the CG typically reflects the purpose of the organization. Thus, in particular embodiments, a service provider may police or otherwise require that the name of the CG be formally associated or authorized with the entity administering the CG. For instance, the service provider may require the “Official Virginia Tech Football” CO to be operated by an alumni organization associated with the Virginia Polytechnic Institute and State University, or other entity authorized to do so.

As can be expected, the names of certain Sponsored CGs may involve trademarked names or other names connoting an affiliation with an organization. Thus, in various embodiments, the organization administering the Sponsored CG may be granted certain authorization as to what capabilities it can extend to the members of the CG. For example, a Sponsored CG may be very popular and by necessity, limit content that viewers may be able to post to various mashups. In other cases, the Sponsored CG may be able to “blacklist” certain members from posting content on mashups. This allows the Sponsored CG administrator, for example, to limit postings on mashups from subscribers which are offensive or otherwise detrimental to the image of the sponsor. In some cases, the sponsor may pay a fee to the service provider to administrator a group having the name, and the sponsor could, in turn, charge fees to its members to allow them to participate. As will be seen, in various embodiments, placing advertisements in mashups available to certain Sponsored CGs may be important because the Sponsored CGs may have widespread appeal and may be very popular among a particular viewer base.

Another type of CG may be a “Private” CG. In various embodiments, this type of CG is often administrated by an individual and the scope of the CG is often (but not necessarily) smaller than that of a Sponsored CG. For example, a family or set of individuals that are close friends may form a Private CG. In another example, viewers who are fans of a particular television show or who have an interest in a particular area (e.g., home renovating and decorating) may form a Private CG.

In various embodiments, because of the size and purpose of the group, the service provider may limit or alter the administrative capabilities provided to the Private CG. For instance, membership criteria may be limited to invitation only or to a defined list of subscribers. Further, notification or publication of the Private CG may be limited. For example, if membership in the group is limited to a defined set of individuals, then there is no need to advertise its existence.

Further, a third type of CG may be a “Topical” or “Public” CG. Unlike the Private CG where membership is limited, in various embodiments, the Topical or Public CG is open and generally available to any subscribers who choose to become a member. The group may be administered by an entity or individual, and may be subject to certain criteria or requirements from the service provider. In various embodiments, membership is generally by self-registration and therefore any subscriber of the service provider can request to join a particular Topical or Public CG.

Finally, a fourth type of CG may be a “View Only” CG. In particular embodiments, this CG typically is open to membership to any subscriber requesting to join. However, in most instances, members are usually not allowed to post content to associated mashups. For instance, this particular type of CG can be compared to a “blog” wherein the content is controlled and generated by the publishers of the associated mashups. Hence, only posts by the publishers are allowed. In particular embodiments, a View Only CG may be used by an administrator/publisher publishing a mashup and the administrator/publisher has a certain “name recognition” or expertise. For example, a well known sports commentator may publish a mashup and make the mashup available to a View Only CG so that only his comments are posted on the mashup. In various embodiments, each CG is identified by a unique name (e.g., “Official Virginia Tech Football” CG). Thus, in most instances, each CG name is unique and typically is reflective of the purpose and common interest of its members. As evident, the different types of CGs are essentially groups having different administrative options, different restrictions, have different advertising potential, etc. Thus, in various embodiments, any number of types of groups can be created, and the types merely reflect a convenient way for the service provider to categorize different aspects. For example, mashups that may be published for the service provider's subscribers at large may be associated with one or more View Only CGs and/or Public CGs. Therefore, it may be logical, based on the prior examples, for such groups to have a membership policy that allows any subscriber of the service provider to join. Similarly, based on the prior example, mashups associated with a Private CG may not be publicized and may be limited to invitation only. Thus, to facilitate such implementation in various embodiments, the service provider may define profiles of the different attributes of the CGs that allow for convenient establishment of groups as opposed to requiring the service provider to creating a unique set of attributes each time a CG is created.

### Community Group Attributes

As mentioned, in various embodiments, the service provider may create a set of CG attributes and classify each as a unique type. Four different types of CGs were described above, however other types of CGs may be created, or the described CG types may be created with different attributes. In particular embodiments, the attributes for a CG type are defined by the service provider, and these attributes may vary. The following is an exemplary list of attributes that can be defined and associated with a CG profile according to a particular embodiment.

Membership Type: this particular attribute defines how subscribers are initially allowed into the CG (e.g., how subscribers can become members). For instance, some membership types may include:
1. Authorized List—the CG administrator identifies each subscriber authorized to join the group. Typically, this type of membership is used for a small CG, such as a Private CG. In particular embodiments, a subscriber may be identified at login using a user-id or other type of identifier.
2. By Invitation—the CG administrator sends a request to a particular subscriber asking the subscriber if he would like to join a particular CG. According to embodiments, the request may be sent to the service provider subscriber community at large, in response to a particular subscriber searching and selecting a particular CG, or by some other basis. In particular embodiments, requests to join may also be sent using other media (e.g., direct mail, email, etc.).
3. By Self Registration—a subscriber initiates a request to join a group, wherein the request is typically automatically allowed.
   In various embodiments, certain Membership Types may be more suitable for certain CG types. For instance, if a CG is intended to have a wide focus, the CG would not likely utilize an Authorized List form of membership establishment because updating list can be time consuming. However, a Sponsored CG may utilize an Authorized List form of membership because the group is limited to subscribers who have paid a membership to an organization sponsoring the CG.

Advertising: this particular attribute defines whether advertising may be provided to the members of the CG. In particular embodiments, defining CGs based on a common interest, such as college football fans, provides a valuable opportunity to include targeted advertising on associated mashups for the CGs.

Content Controls: this particular attribute defines what type of controls may be defined for members with respect to providing content. In various embodiments, the Content Control attribute indicates whether a member can post content on associated mashups and/or indicates limitations on the content (e.g., duration, whether it was generated from a present video program, or previously recorded, with or without annotation). In particular embodiments, Content controls may be defined for all members or for a subset of members.

Publication of the CG Name: this particular attribute defines aspects related to publication of the CG name. Typically, publication of a CG name is performed to increase membership. In various embodiments, this attribute encompasses how and when the CG name will be informed to the membership at large. For example, a list of current CG names may be provided to a subscriber upon request or the subscriber may search a list of CGs affiliated with a particular topic. Further, in particular embodiments, certain CGs may be restricted from publication, e.g., a Private CG.

Black List Creation: this particular attribute defines whether a “black list” of members may be created to preclude these members from providing content for associated mashups, or excludes membership of a subscriber. In particular embodiments, this attribute addresses the situation in which one or more members of a CG are ‘disrupting’ the functioning of the CG and associated mashups by posting offensive content. For instance, a member of a CG (e.g., identified by user-id, which is typically linked to a set-top box identifier) may be added to a blacklist to exclude the member from participation in interactive functions on mashups associated with the CG.

As is understood by those of ordinary skill in the art, other CG attributes may be defined in various embodiments. Therefore, the above list is only exemplary as to the type of attributes that may be linked to a CG.

### Community Group Administration

The CG administration refers to actions typically performed by the CG administrator. In particular embodiments, the CG administrator typically is the individual who has created the CG. Further, in some embodiments, the CG administrator is the same individual that is the publisher of the mashups associated with the CG.

In general, the CG administrator performs various functions associated with creating, maintaining, and managing membership in the CG in various embodiments. In many instances, the administrator includes one or more members. Typically, the service provider authorizes the CG administrator to perform certain functions in the group, and these functions may be indicated either by interacting over the cable system or accessing a community group management system (“CGMS”) via a computer through the Internet. However, for purposes of this disclosure, an embodiment is discussed in the context of the administrator using a set-top box to administer the group.

Typically, the CG administrator performs a series of selections when the CG group is initially established. For instance, in one embodiment, the CG administrator is provided with a series of “pages” displayed on the television, and the administrator provides input using a remote control or other suitable device to provide information such as the name of the CG, type, and to select a particular attribute option. As noted above, in various embodiments, the possible attributes that the CG administrator may select is determined by the CG type. Further, the CG administrator may require that for certain group types the CG group administrator “manually” register (e.g., provide information through another channel, than using the set-top box). For example, if the CG administrator desires to establish a Sponsored CG in which advertising is involved, the CG administrator may be required to execute a contract with the service provider before that type of CG can be established. In other embodiments, the use of a particular name for a Sponsored CG (implying affiliation with a certain group or trademark holder) may require that a due diligence investigation is performed by the service provider before that CG name is registered in the system. This would avoid unauthorized individuals establishing a Sponsored CG with names implying an affiliation when they are not authorized to do so.

### System Architecture

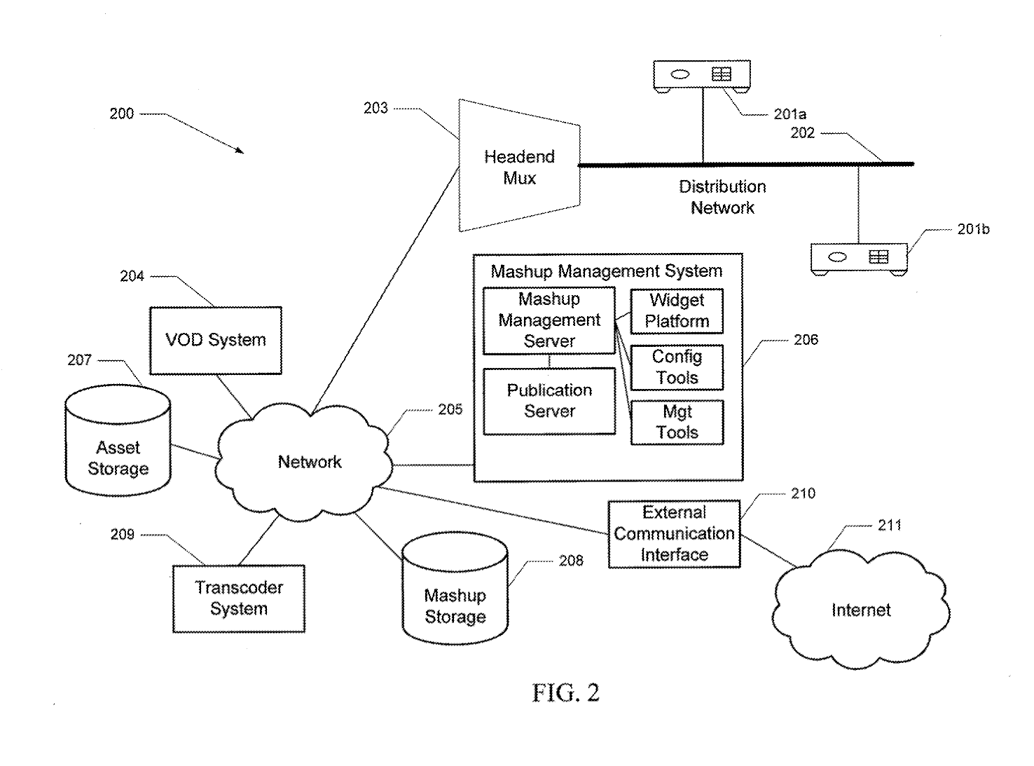

A system architecture 200 supporting social mashups according to various embodiments of the invention is shown in FIG. 2. For instance, the system architecture 200 may be related to a cable provider's system architecture 200 providing cable programming to the cable provider's subscribers. However, the system architecture 200 may also be a satellite TV provider's system. Therefore, the system architecture 200 depicted in FIG. 2 is provided for illustrative purposes only and should not be construed to limit the scope of the claimed invention.

As may be understood from this figure, in various embodiments, the system architecture 200 includes one or more set-top boxes 201a, 201b. In general, these set-top boxes 201a, 201b are devices that are used by subscribers to receive digital cable signals for television and are configured to send data to the headend 203 residing in the system architecture 200. For example, one of the set-top boxes 201a, 201b may be a device, such as a personal video recorder (PVR) provided by a cable company: The PVR receives the digital cable signal and feeds the signal into a subscriber's television set so that the subscriber can view the cable company's cable television programming.

As shown, in various embodiments, the set-top boxes 201a, 201b communicate with the headend 203 over a distribution network 202. The headend 203 routes messages (e.g., subscriber inputs) received from the set-top boxes 201a, 201b to various components of the provider's system architecture 200 and streams content (e.g., selected VOD programs) to the set-top boxes 201a, 201b. For instance, in one embodiment, the headend 203 receives input from the subscriber via one of the set-top boxes 201a, 201b, interprets the input, and sends the input to the appropriate component of the system architecture 200, such as the VOD system 204 or the mashup management system 206. In various embodiments, the mashup management system 206 may include several components such as a mashup management server, a publication server, a widget platform, configuration tool, and management tool. As is described in greater detail below, these components are used in providing subscriber's with the necessary mechanisms for configuring, publishing, managing, and viewing mashups. Further, in particular embodiments, the mashup management system 206 may include components that are used to configure and management community groups (CGs). However, in other embodiments, the system architecture 200 may include a separate CG management system (not pictured) or the system architecture 200 may be in communication with a CG management system.

In addition, the system architecture 200 in various embodiments may also include a transcoder system 209. This system 209 is configured to perform specific functions within the system architecture 200. For instance, described in further detail below, the transcoder system 209 may include software and/or hardware components configured to transcode various content into a format that is compatible with the provider's distribution network 202 and corresponding set-top boxes 201a, 201b. Furthermore, several of the components of the system architecture 200 are connected via a network 205 within the system architecture 200 (e.g., a LAN, a wireless network, and/or a private network) and communicate with one another.

As depicted in FIG. 2, the system architecture 200 may also include storage media, such as asset storage 207 and mashup storage 208. The storage media 207, 208 is also connected via the network 205 and communicates with other components of the system architecture 200. In various embodiments, the asset storage 208 may store content assets available through the provider's distribution network 202 (e.g., through the provider's VOD service) and the mashup storage 208 may store publishers' mashup configurations and/or the content for the mashups. Furthermore, in various embodiments, the system architecture 200 may include an external communication interface 210 that is in communication with the Internet 211.

In various embodiments, the components of the system architecture 200 may be one or more devices or may include one or more devices executing software programs. Furthermore, in various embodiments, the storage media 207, 208 may be one or more types of media such as hard disks, magnetic tapes, or flash memory.

### Exemplary Mashup Management Server

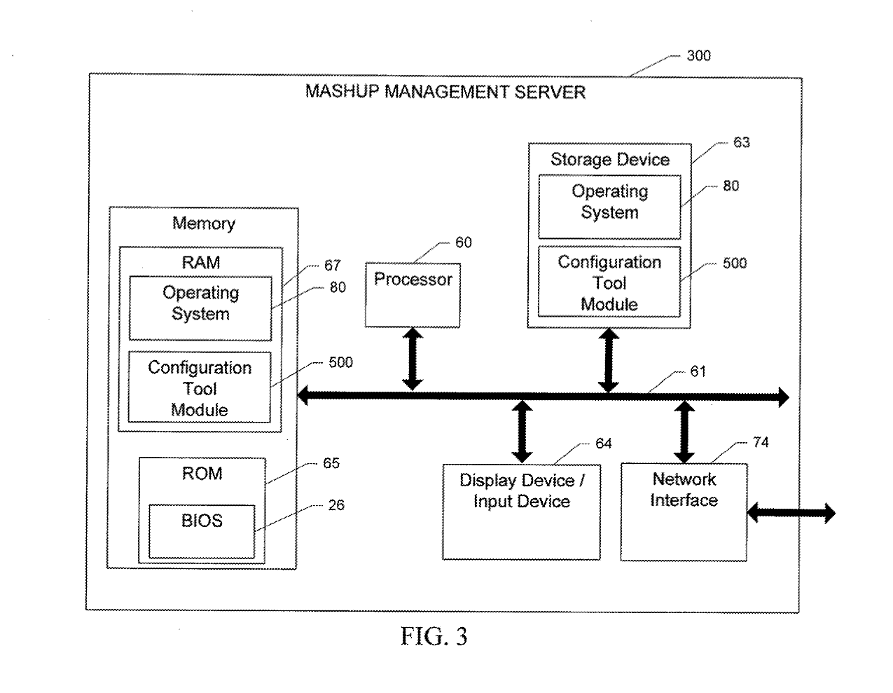

FIG. 3 shows a schematic diagram of the mashup management server 300 shown in the mashup management system 206 depicted in FIG. 2 according to one embodiment of the invention. In this particular embodiment, the mashup management server 300 is provided as a single server. However, it should be understood that the mashup management server 300 does not necessarily need to be a single server. For instance, in various embodiments, the mashup management server 300 may be provided via one or more servers executing one or more software applications. Thus, the server 300 shown in FIG. 3 is provided for illustrative purposes only and should not be construed to limit the scope of the invention.

In FIG. 3, the server 300 includes a processor 60 that communicates with other elements within the server 300 via a system interface or bus 61. Also included in the server 300 is a display device/input device 64 for receiving and displaying data that may be used by administrative personnel. This display device/input device 64 may be, for example, a keyboard or pointing device that is used in combination with a monitor. The server 300 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 300. Alternatively, the server 300 can operate on one computer or on multiple computers that are networked together.

In addition, the server 300 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for the server 300. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. For example, as shown in FIG. 3, program modules of the mashup server 300 may include an operating system 80 and a configuration tool module 500. This module 500 may be used to control certain aspects of the operation of the server 300, as is described in more detail below, with the assistance of the processor 60 and an operating system 80.

Also located within the server 300 is a network interface 74, for interfacing and communicating with other elements of one or more networks (such as the network 205 described in the system architecture 200 depicted in FIG. 2.) It will be appreciated by one of ordinary skill in the art that one or more of the server's 300 components may be located geographically remotely from other server 300 components. Furthermore, one or more of the components may be combined, and additional components performing functions described herein may be included in the system architecture 200.

### Additional Exemplary Components

The publication server shown in the mashup management system 206 depicted in FIG. 2 may also include components and functionality similar to that of the mashup management server 300. For example, in one embodiment, this server may include: (1) a processor that communicates with other elements via a system interface or bus; (2) a display device/input device; (3) memory including both ROM and RAM; (4) a storage device; and (5) a network interface. Further, the server may include a number of program modules stored by the various storage devices and within RAM of the server. For example, program modules of the server may include an operating system 80 and a publication module 600. This module 600 may be used to control certain aspects of the operation of the server, as is described in more detail below, with the assistance of the processor and an operating system.

Thus, these server architectures are provided for exemplary purposes only and are not limiting to the various embodiments. The term “server” is used generically to refer to any computer, computing device, desktop, notebook or laptop, distributed system, server, gateway, switch, or other processing device adapted to perform the functions described herein.

### Exemplary Set-Top Box

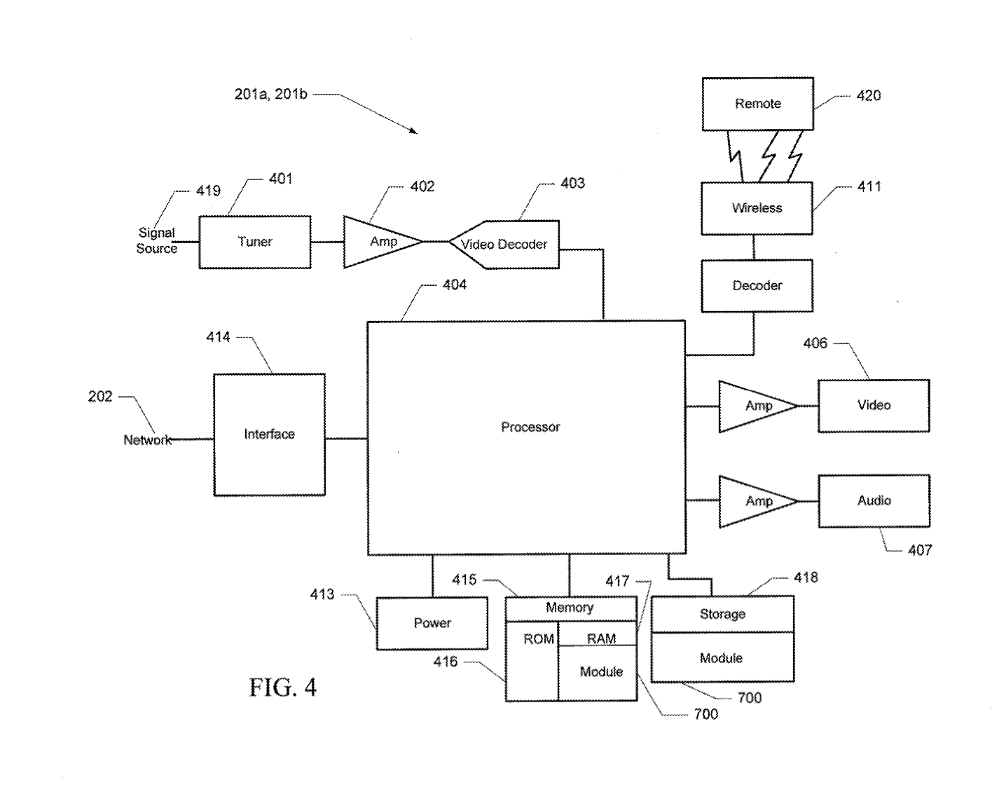

FIG. 4 shows a schematic diagram of one of the set-top boxes 201a, 201b depicted in FIG. 2 according to one embodiment. The particular set-top box is configured to receive a digital signal from a cable provider or a satellite TV provider and to convert the signal into audiovisual content that is typically displayed on a television.

The set-top box 201a, 201b includes a processor 404 and storage 418, such as a hard disk drive and/or a flash drive, on which audiovisual data may be recorded and stored by the processor 404. In addition, the set-top box 201a, 201b further includes memory 415 composed of both read only memory (ROM) 416 and random access memory (RAM) 417.

The set-top box 201a, 201b further includes a tuner 401 configured to receive the incoming source signal 419. The tuner 401 sends the source signal 419 through an amplifier 402 and a video decoder 403 configured to translate the encoded source signal 419 into its original format. The video decoder 403 directs the translated source signal 419 to the processor 404. Furthermore, the processor 404 is configured to feed the translated signal to the video and audio outputs 406, 407 of the set-top box 201a, 201b that are connected to the television.

In addition, the set-top box 201a, 201b may also include a wireless interface 411 that is configured to receive commands (and/or input) from a viewer via transmission from a remote control 420. The remote control 420 may transmit such commands using any number of transmitters, such as a radio frequency transmitter, a supersonic transmitter, or an optical transmitter. Further, the remote control 420 may be configured with cell-phone-spelling style features so that a subscriber may enter text.

A number of program modules (such as module 700) may also be stored within the storage 418 and/or within the RAM 417 of the set-top box 201a, 201b. This module 700 may be used to control certain aspects of the operation of the set-top box 201a, 201b, as is described in more detail below, with the assistance of the processor 404.

Also located within the set-top box 201a, 201b is an interface 414, for interfacing and communicating with other elements of a network (such as the headend 203 in communication with the distribution network 202 described in the system architecture 200 depicted in FIG. 2.) It will be appreciated by one of ordinary skill in the art that one or more of the set-top box's 201a, 201b components may be located geographically remotely from other set-top box 201a, 201b components. Furthermore, one or more of the components may be combined, and additional components performing functions described herein may also be included in the set-top box 201a, 201b.

### Exemplary System Operation

In various embodiments, system operation can be considered as two phases. The first phase of system operation (e.g., configuration phase) involves utilizing a configuration tool module 500 so that a publisher can configure a mashup and publish the mashup for viewing in the provider's distribution network. The second phase of system operation involves providing a subscriber with a requested mashup for viewing and allowing the subscriber to interact with the mashup (e.g., viewing phase). For instance, in various embodiments, the publication server includes a mashup module 600 that is adapted to provide the subscriber with a mashup, to provide additional content for items selected by the subscriber on, the mashup, and to provide interactive components on the mashup. Furthermore, in various embodiments, the set-top box 201a, 201b may include a module 700. In these particular embodiments, this module 700 is adapted to perform one or more tasks such as allow the subscriber to select to view additional content for a particular content item on the mashup and to allow the subscriber to interact with the mashup and post content on the mashup. These modules 500, 600, 700 are described in more detail below.

### Configuration Tool Module

As previously discussed, in various embodiments, the mashup management system 206 includes a configuration tool module 500 that is adapted to provide the tools necessary to allow a publisher to configure a mashup. The publisher may access these tools (e.g., the module 500) in various ways according to embodiments. For instance, in one embodiment, the publisher accesses the module 500 through a set-top box 201a, 201b. Thus, for example, the publisher may call up an application on the publisher's television that resides in the VOD service on the publisher's set-top box 201a, 201b or that resides in a stand-along service. In another embodiment, the publisher may access the configuration tool module 500 through one or more Web pages. For example, the mashup management system 206 may be in communication with an external communication interface 210 that provides a website on the Internet 211 (as shown in the architecture 200 depicted in FIG. 2). Thus, the publisher visits the website over the Internet 211 and configures the mashup by accessing the configuration tool module 500 through the website.

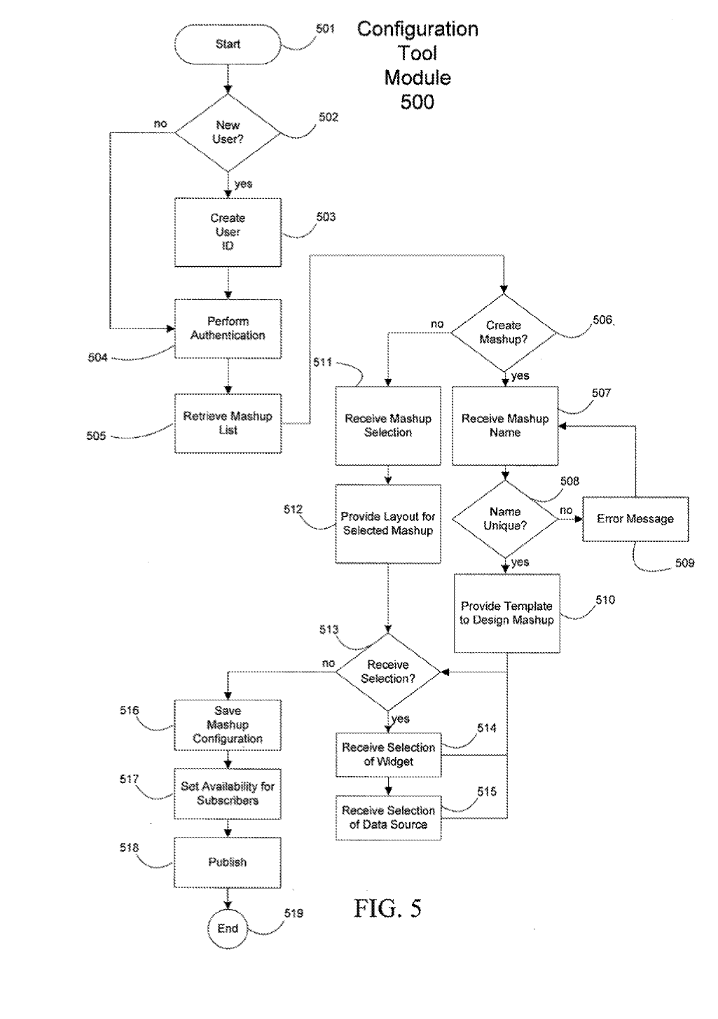

Accordingly, FIG. 5 illustrates a flow diagram of a configuration tool module 500 according to various embodiments. This flow diagram may correspond to the steps carried out by the processor 60 in the mashup management server 206 shown in FIG. 3 as it executes the module 500 in the server's RAM memory 67 according to various embodiments.

Therefore, the publisher enters into the configuration tool and the configuration tool module 500 determines whether to create a user identifier for the publisher, shown as Step 502. In various embodiments, the publisher may be provided with an initial login screen. For instance, in one embodiment, the screen requests the publisher's username and password or provides an option for the publisher to create a username and password. Therefore, the publisher may select the option to create a username and password and enters a username and password (along with other relevant information) on a subsequent screen. In response, the configuration tool module 500 verifies the username and password are valid (e.g., verifies that the username and/or password are unique) and creates the user identifier, shown as Step 503.

In various embodiments, the user identifier uniquely identifies the particular publisher and can be used to retrieve the publisher's configurations and allow the publisher to manage the configurations of the publisher's mashups. Once the module 500 has created the identifier, the module 500 may save the identifier in some storage medium, such as the mashup storage 208 shown in the system architecture 200 depicted in FIG. 2.

If the configuration tool module 500 determines that a user identifier does not need to be created, in various embodiments, the module 500 may perform an authentication process for the particular publisher, shown as Step 504. For instance, in one embodiment, the module 500 may read the publisher's username and password and may confirm the username and password match (that is, the module 500 may confirm the publisher has entered the correct password for the entered username).

Once the configuration tool module 500 authenticates the publisher's username and password, the module 500 retrieves a list of mashups associated with the publisher, shown as Step 505. For instance, in one embodiment, the configuration tool module 500 queries the mashup storage 208 (using the publisher's unique identifier, for example) to retrieve a list of mashups (e.g., the name of mashups associated with the particular publisher).

In Step 506, the configuration tool module 500 determines whether the publisher wants to create a mashup or whether the publisher wants to edit an existing mashup. For instance, in one embodiment, the publisher selects an option to create a mashup by pressing a button on the publisher's remote control. The publisher is presented with a screen to type in a name for the mashup. The publisher enters a name for the mashup and in turn the configuration tool module 500 receives the mashup name, shown as Step 507.

In particular embodiments, the name entered by the publisher must be unique to the service provider's system. Thus, in these particular embodiments, the configuration tool module 500 confirms the name entered by the publisher is unique, shown as Step 508. For instance, in one embodiment, the configuration tool module 500 queries a listing of mashup names based on the name entered by the publisher. If the configuration tool module 500 finds a match, the configuration tool module 500 facilitates having a message displayed to the publisher that indicates that the name already exists for a mashup in the service provider's system and asks the publisher to enter a new name, shown as Step 509.

However, if the configuration tool module 500 determines the name does not already exist in the service provider's system, the configuration tool module 500 provides the publisher with a first screen that requests the publisher to select a layout template for the mashup. In particular embodiments, the module 500 may provide the publisher with a listing of screen layout templates to choose from. The publisher scrolls through the listing and reviews the different layouts that are available. The publisher selects a particular layout and the configuration tool module 500 receives the publisher's selection and provides the screen template so that the publisher may design a layout on the template, shown as Step 510.

On the other hand, if in Step 506, the configuration tool module 500 determines the publisher does not want to create a mashup, the configuration tool module receives a mashup selection from the publisher, shown as Step 511. For instance, in one embodiment, the publisher scrolls through the list of mashups associated with the publisher and selects a particular mashup from the list. Thus, in Step 512, the configuration tool module 500 provides the layout for the selected mashup so that the publisher may edit the layout.

Further, in various embodiments, the publisher can access a widget platform through the configuration tool module 500. Thus, in these particular embodiments, the publisher designs the mashup by selecting widgets and placing the widgets on the template. For example, the widgets may include boxes for displaying text, graphics, video, or audio, buttons for initiating actions such as retrieving content, tools for making various kinds of selections such as drop-down menus and scrolling lists. Thus, the publisher selects a particular widget and places the widget on the template at the desired location. Furthermore, the publisher may edit the mashup layout by deleting a particular widget from the template and/or adding a new widget to the template.

Further, in various embodiments, the widget platform may include one or more widgets that provide interactive functionality to the mashup. For instance, the widget platform may provide a box in which subscribers viewing the mashup can enter text messages. In particular embodiments, the messages may scroll as other subscribers enter new messages. Therefore, subscribers can post messages on the mashup that other subscribers can read and respond to. In various embodiments, the widget platform may provide additional interactive widgets such as widgets that enable subscribers to post content such as text documents, videos, and/or audio. For example, the widget platform may provide a widget in which a subscriber viewing the mashup can post a video by providing a URL for the location of the video.

In Step 513, the configuration tool module 500 determines whether the publisher has provided a selection of a particular widget and has associated a particular data source with the widget to include in the mashup. For instance, in one embodiment, the publisher selects a text box widget and places the text box widget on the template in the desired location. The publisher may then wish to associate the text box with a particular data source that is used to populate the text box with content. For instance, in one embodiment, the module 500 provides the publisher with a “freeform” so that the publisher may enter information into the freeform to indicate what content is to be provided in the text box. For example, the freeform may allow the publisher to type in one or more URLs on the freeform area as data sources for the particular widget (e.g., text box).

In other embodiments, the configuration tool module 500 provides a listing of data sources available for the publisher to select from. In these particular embodiments, the publisher selects from the listing to identify the data sources for the particular widget on the mashup. For example, the module 500 may provide one or more data sources for widgets such as: (1) the ESPN® website; (2) the CBS Sports® website; and (3) the official website of Major League Baseball®. In further embodiments, the configuration tool module 500 may provide a listing of available data sources and may also allow the publisher to enter one or more data sources. For instance, the publisher may select the website for ESPN® from a listing of data sources and may enter by freeform one or more celebrities from Tweeter® as additional data sources.

If the configuration tool module 500 determines that the publisher has provided a selection of a widget, the module 500 receives the publisher's selection of the widget and corresponding data source, if applicable, shown as Steps 514 and 515. Further, in particular embodiments, the configuration tool module 500 may receive a format for the widget, such as font size of text, color of the text, and/or whether the text is to be voice synthesized.

At this point, the configuration tool module 500 determines whether the publisher has selected another widget and corresponding data source. If the module 500 determines that an additional selection has been made, the module 500 continues with the process already described in which the module 500 receives the selection of the widget and receives the data source for the widget, if applicable (that is, the module 500 repeats Steps 514 and 515). This process continues until the configuration tool module 500 determines the publisher has not selected any additional widgets.

In response to the publisher not entering any additional selections of widgets, the module 500 saves the configuration for the mashup, shown as Step 516. The module 500 may save the configuration in one or more storage media on the provider's system or in one or more storage media external to the provider's system. For example, in one embodiment, the configuration tool module 500 saves the configuration in a database along with a unique identifier so that the configuration may be retrieved from the database. Yet, in another embodiment, the configuration tool module 500 may save the configuration in a file and store the file. In this particular embodiment, the module 500 may also store a record in the database that includes the storage location of the file along with the unique identifier so that the file may be retrieved from storage upon request. One of ordinary skill in the art can envision several ways to store the configuration in light of this disclosure.

In Step 517, the publisher sets availability of the mashup for subscribers of the service provider. For instance, the publisher may indicate that the mashup is available to all subscribers for the service provider. Thus, in particular embodiments, the configuration tool module 500 associates an indicator that indicates the mashup is available to all subscribers. For instance, in one embodiment, the configuration tool module 500 saves an identifier for the mashup in a database along with the indicator. Therefore, in this particular instance, the database may be queried to identify the mashups available to the all of the subscribers.

In other embodiments, the publisher may identify particular subscribers that may have availability to the mashup. For instance, in these embodiments, the publisher may select the subscribers, one-by-one, from a list of subscribers for the service provider to identify the subscribers that may have access to the mashup. One or more records may then be saved that show these subscribers have been associated with the particular mashup.

Further, in other embodiments, the publisher may identify one or more particular CGs that may have access to the mashup. As previously discussed, the service provider may allow for CGs to be formed on the provider's system and these groups include subscribers (e.g., members). Therefore, in these particular embodiments, the publisher may simply select one or more CGs to make his mashup available to and as a result the mashup is available for access to the members of the CGs. Using such an access mechanism may be very beneficial in various embodiments. For instance, a publisher may wish to provide a mashup on the service provider's system for a subscription fee. In this instance, the publisher may form a CG (e.g., Sponsored or Private CG) and include subscribers that have paid the subscription fee. Therefore, the publisher only needs to provide the CG access to his mashup in order to provide his subscribers with access to his mashup. Further, by using the CG in various embodiments, the publisher can easily manage the functionality of subscribers. For instance, the publisher can easily deny access to the mashup for a particular subscriber by removing the subscriber from the CG. In addition, the publisher can assign the various subscribers with different “rights” with respect to the mashup through the CG.

Once the publisher has set the availability for subscribers, the publisher publishes the mashup in Step 518. Once this step is completed, the mashup is available for viewing by various subscribers in the service provider's system. As mentioned, in particular embodiments, the availability is based on who the publisher has identified (in Step 517). Therefore, if the publisher has published the mashup so that it is available to all of the subscribers of the service provider, any subscriber may select the mashup for viewing. However, if the publisher has only identified a certain number of subscribers, only those subscribers may select the mashup for viewing.

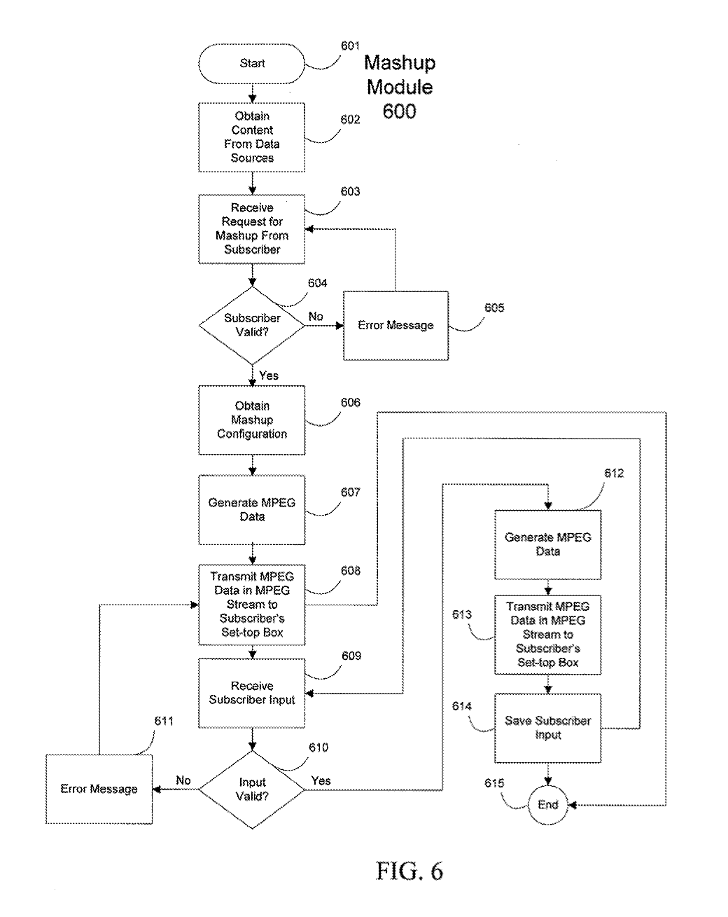

As previously mentioned, in various embodiments, the publication server may includes a mashup module 600 that is configured to provide a subscriber with a desired mashup and/or associated content for displaying on the mashup. In various embodiments, the publication server is located at a central location within the provider's system (for example, as shown in FIG. 2) and receives a request that is routed over the provider's cable distribution network 202 from the subscriber's set-top box 210a, 201b. Accordingly, FIG. 6 illustrates a flow diagram of the mashup module 600 according to various embodiments. This flow diagram may correspond to the steps carried out by the processor in the publication server as it executes the module 600 in the server's RAM memory according to various embodiments.

For instance, in various embodiments, the subscriber may request a selected mashup to be streamed to his set-top box 210a, 201b. The subscriber's request is sent over the provider's distribution network 202 to the provider's headend 203. In various embodiments, this request may include a unique identifier or some other mechanism to identify the selected mashup. In turn, the headend interprets the request and routes the request to the publication server.

In various embodiments, the mashup module 600 may poll the information from the various data sources at different stages of providing the mashup and/or content for the mashup. For instance, in various embodiments, the mashup module 600 may obtain content from the data sources prior to receiving the subscriber's request. Thus, in Step 602, the mashup module 600 obtains content from various data sources. In one particular embodiment, the mashup module 600 may be configured to poll the data sources at a predetermined interval of time and store the content locally in one or more storage media. For instance, the mashup management system 206 may store a listing of the various data sources that provide content to mashups provided in the provider's distribution network 202.

In one embodiment, the listing may be stored in a database. The mashup module 600 queries the database to determine whether a particular data source needs to be polled. For instance, the database stores the date and time along with each data source that indicates the last time the data source was polled. If the mashup module 600 determines the predetermined time period has elapsed since the last time a particular data source has been polled, the mashup module 600 polls the particular data source to obtain content from the data source.

In another embodiment, the mashup module 600 may use information associated with the data source to determine whether the source should be re-polled. For instance, the mashup module 600 may be configured to analyze cache controls found in a HTTP header. For example, the “Expires” control found in various HTTP headers is a date and time that tells how long the associated representation (e.g., associated HTML pages, images, and files) of the Web page is fresh. Therefore, the mashup module 600 checks this control to determine whether the associated content has expired and needs to be re-polled. The mashup module 600 may use other useful cache controls such as max-age, which specifies the maximum amount of time that a representation of a Web page will be considered fresh.

In one embodiment, the mashup module 600 may store a representation of the Web page associated with a data source, associated links, and embedded pages locally in one or more storage media. For example, the mashup module 600 stores a representation of the ESPN® Web page and the pages associated with any links found on the Web page.

In another embodiment, the mashup module 600 may only store a representation of the first Web page associated with the data source and may record any links associated with the first Web page. As a result, in these embodiments, the amount of content stored for any one data source is minimal. Thus, in various embodiments, there are several combinations of content that the mashup module 600 can be configured to obtain from each data source.

Return to FIG. 6, at Step 603, the mashup module 600 receives a request for a particular mashup from the subscriber. In Step 604, the mashup module 600 determines whether the subscriber is a “valid” subscriber that can view the mashup. For instance, in a particular embodiment, the mashup module 600 determines whether the subscriber is associated with a CG that has been given availability to the particular mashup and/or whether the individual subscriber making the request has been given availability to the particular mashup. For example, the mashup module 600 may query a list of CGs that have been given availability to the particular mashup and then may query the individual CGs on the list to determine whether the subscriber is a member of any of the CGs.

If the mashup module 600 determines the subscriber does not have availability to the requested mashup, the mashup module 600 facilitates having an error message displayed to the subscriber informing him that the mashup is not available for him to view, shown as Step 605. For instance, in one embodiment, the mashup module 600 sends a message over the distribution network 202 to the subscriber' set-top box 201a, 201b and the set-top box 201a, 201b generates a message on the subscriber's television informing him that he is not “authorized” to view the mashup.

On the other hand, if the mashup module 600 determines the mashup is available for viewing by the subscriber, in various embodiments, the mashup module 600 obtains the configuration for the mashup from storage, shown as Step 606. Thus, the mashup module 600 reads the various data sources from the configuration and retrieves from the stored content the content for the particular data sources.

It should be noted that in particular embodiments, the mashup module 600 may be configured to obtain the content from the data source after receiving the request from the subscriber for the mashup. In these embodiments, the mashup module 600 receives the request for the mashup and, in response, obtains the configuration for the mashup and determines from the configuration what data sources are used for content displayed on the mashup. In a similar fashion as described above, the mashup module 600 then obtains the content from each data source specified in the configuration. Thus, in these particular embodiments, the mashup module 600 does not obtain the content for the mashup until the module 600 has received the request from the subscriber. An advantage in various embodiments that use this approach is that the content displayed on the particular mashup is always up to date. Therefore, in these particular embodiments, there is no need many times to rely on mechanisms to determine whether a data source needs to be re-polled.

Furthermore, it should be appreciated that the mashup module 600 in various embodiments is configured to do both. That is, in various embodiments, the mashup module 600 is configured to both obtain content from various data sources prior to receiving the request from the subscriber and obtain content from other data sources after receiving the request from the subscriber. For instance, in particular embodiments, the mashup module 600 may be configured to poll certain data sources and store representations of these data sources locally because these sources are popular among various mashups. That is, these particular data sources are selected by a large number of the publishers as content for their mashups. Therefore, in various embodiments, associated content for these data sources can be retrieved more quickly than having to poll the actual data source each time a mashup is requested that is configured with content from one of these data sources. In addition, the mashup module 600 may be configured to obtain the content from the less popular data sources after receiving a request for a mashup that includes content from one of these data sources. Therefore, in various embodiments, the storage requirements may be reduced because the content for less popular data sources is not stored locally.

Returning to FIG. 6, the mashup module 600 then generates MPEG data comprising one or more MPEG frames from at least a portion of content for the requested mashup, shown as Step 607. As previously discussed, the mashup module 600 in various embodiments may generate data packets in an encoding format compatible with the provider's system architecture 200. For instance, in one embodiment, the mashup module 600 calls a transcoder system 209 to transcode the portion of content into a format compatible with the provider's VOD system 204, such as CableLabs® MPEG2 Transport SD, CableLabs® MPEG2 Transport HD, H.264 Transport SD with MPEG audio or AAC audio, H.264 Transport HD with AAC audio, and/or H.264 web format with AAC audio.

In Step 608, the mashup module 600 has the MPEG data transmitted in an MPEG stream to the subscriber's set-top box 201a, 201b. Therefore, in the system architecture 200 depicted in FIG. 2, the stream is transmitted from the provider's headend 203, over the provider's cable distribution network 202, to the subscriber's set-top box 201a, 201b. In many instances, the stream containing the data is also transmitted as a unicast stream to the subscriber's set-top box 201a, 201b similar to VOD content. In other embodiments, the headend 203 combines the mashup (e.g., MPEG data) with programming being streamed to the subscriber's set-top box 201a, 201b into a combined stream.

In various embodiments, the mashup is provided like any other type of content that is streamed to the set-top box 201a, 210b and the set-top box 201a, 210b simply generates signals to display the mashup as received. For instance, in one embodiment, the mashup module 600 may utilize a system to construct one or more MPEGs, such as I-frames, to represent the mashup and the MPEGs may be streamed to the subscriber's set-top box 201a, 201b. Such a system is detailed in U.S. patent application Ser. No. 12/406,493 filed on Mar. 18, 2009 and entitled “Systems and Methods, for Providing a Dynamic User Interface for a Settop Box,” which is incorporated herein by reference in its entirety.

Further, as previously described, the displayed mashup may include components (e.g., widgets) that allow the subscriber to interact with the mashup. For instance, in particular embodiments, the mashup may include a text box in which the subscriber may provide messages for posting on the mashup. These messages may be provided for posting on the mashup in different ways. For example, in one embodiment, the subscriber may enter a text message for posting using the subscriber's remote control in communication with the subscriber's set-top box 201a, 201b. In this example, the subscriber selects the text box on the mashup using his remote control and types in a message using various buttons on the remote control. Once he has completed typing in the message, the subscriber selects a “submit” button on the remote control to post the message on the mashup.

In another example, the subscriber may send a message to be post on the mashup via instance messaging using the subscriber's cell phone. In this example, the subscriber sends an instance message to a phone number associated with the service provider. The instance message includes the text for posting on the mashup along with an identifier for the mashup. The service provider's system receives the message and routes the message to the publication server.

Further, in another example, the subscriber may send a message over the Internet to the service provider's system. For instance, the service provider may provide a website the subscriber visits and enters a message for posting on the mashup. In similar fashion to posting a message via instance messaging, the subscriber types in the text message and provide an identifier for the particular mashup. The message is then routed through the provider's system to the publication server.

Thus, returning to FIG. 6, the mashup module 600 receives input from the subscriber in Step 609. In particular embodiments, the mashup module 600 determines whether the input is valid, in Step 610. As previously described, a subscriber may have certain privileges with respect to the mashup. Therefore, in particular instances, a subscriber may not have the privilege to post content on the particular mashup (e.g., the subscriber may have been placed on a “black list” because the subscriber had previously posted offensive material on the mashup). If the mashup module 600 determines the input is invalid (e.g., the subscriber is not allowed to post content on the mashup), the mashup module facilitates having an error message displayed to the subscriber informing him that he is not allowed to post the message, shown as Step 611.

However, if the mashup module 600 determines the input is valid, the mashup module 600 generates an MPEG data for the mashup that displays the content entered by the subscriber, shown as Step 612. Thus, in the example, the mashup module 600 generates MPEG data for the mashup that displays the text message in the text box. In Step 613, the mashup module 600 has the data transmitted in a MPEG stream to the subscriber's set-top box 201a, 201b. As a result, the set-top box 201a, 201b displays the mashup on the subscriber's television with the text message displayed in the text box on the mashup.

Further, according to various embodiments, if other subscribers are also viewing the mashup at the time the subscriber enters the text message, the MPEG data is also streamed to their set-top boxes 201a, 201b. As a result, these subscribers also view the subscriber's text message displayed in the text box on the mashup. In similar fashion, the subscribers may also enter a text message to be displayed in the text box on the mashup. For instance, in particular embodiments, the text box may be configured to scroll the messages with the most recent messages listed at the top. Therefore, a subscriber may be able to view a history of messages posted on the mashup. As a result, the mashup provides an interactive component in various embodiments that allows subscribers to post content on the mashup and to interactive with each other via posted content.

As previously mentioned, other types of content besides text may also be posted in various embodiments, such as video and/or audio. This content may be posted in similar fashion. For instance, in one embodiment, the mashup may be configured to allow subscribers to post videos on the mashup so that other subscribers may view the video. In this particular embodiment, the subscriber may provide a URL, for example, that points to the location of the video along with a description of the video. In turn, the description along with a link to the URL may be posted on the mashup that may be selected by a subscriber to view the particular video.

Finally, in Step 614, the mashup module 600 saves the subscriber's input in various embodiments. The subscriber's input may be saved in storage media within the service provider's system or in media external to the service provider's system. This step may be carried out by the mashup module 600 so that subsequent generations of the mashup may show past postings of subscribers. For instance, a subscriber may post a message on a particular mashup and two days later, another subscriber may request to view the mashup. In this particular instance, the mashup module 600 retrieves the previously posted message from storage and generates MPEG data for the mashup that includes the message. As a result, the second subscriber is able to view the first subscriber's message posted on the mashup two days previously.

### Set-Top Box Module

In various embodiments, the subscriber's set-top box 201a, 201b may include some type of module 700 that is adapted to receive data (e.g., in an MPEG stream) for a requested mashup and provide a signal based on the data that is used to display the mashup (and corresponding content) on the subscriber's television screen. In particular embodiments, this module 700 may be a module that already exists on the subscriber's set-top box 201a, and 201b and has been modified to include mashup capabilities. For example, in various embodiments, the VOD module that resides on the set-top box 201a, 201b and provides VOD service for the subscriber may be modified to also provide mashup capabilities. In other embodiments, this module 700 is a stand-along module that resides on the set-top box 201a, 201b.

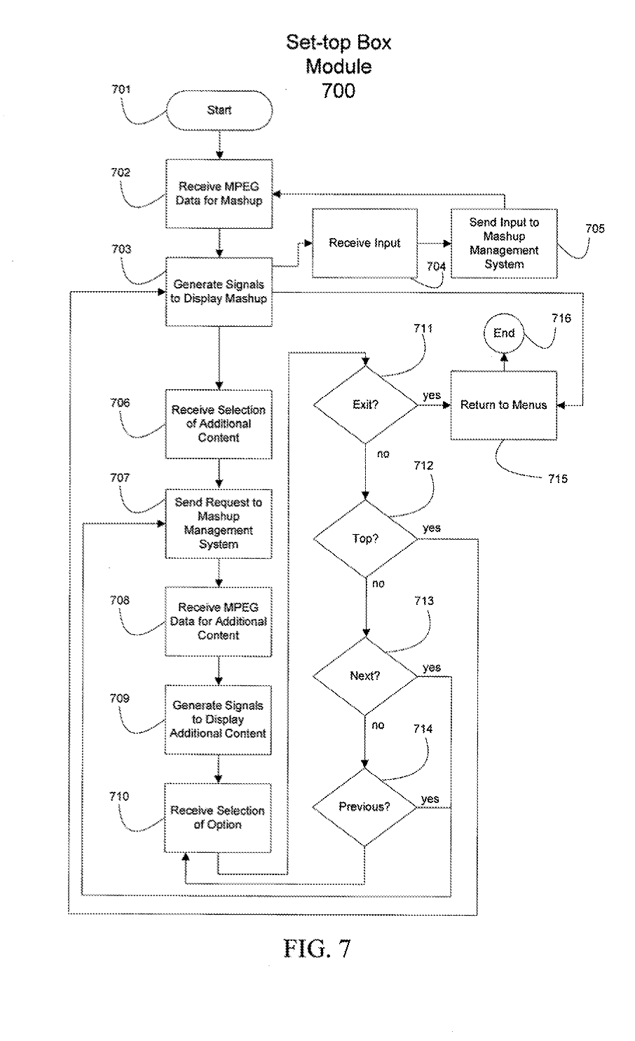

Accordingly, FIG. 7 illustrates a flow diagram of the set-top box module 700 according to various embodiments. This flow diagram may correspond to the steps carried out by the processor 404 in the set-top box 201a, 201b shown in FIG. 4 as it executes the module 700 in the set-top box's RAM memory 417 according to various embodiments.

In Step 702, the set-top box module 700 receives a MPEG stream that includes data for the mashup. In response, the module 700 simply generates signals from the MPEG data to display the mashup on the subscriber's television, shown as Step 730. In various embodiments, the mashup includes content for the applicable widgets identified in the mashup's configuration. Further, the mashup may include widgets with interactive capabilities that allow the subscriber to post content on the mashup.

The subscriber can then read and view the content for mashup on the screen. In particular instances, the subscriber may wish to post content on the mashup. For example, the mashup may provide the current headlines from the CNN® website and the subscriber reads a particular headline and wishes to post a comment on the headline. In various embodiments, the subscriber enters the comment through some mechanism, such as the subscriber's remote control, a keyboard in communication with the set-top box 201a, 201b, and/or an on-screen keyboard, and sends a request to the set-top box module 700 for the additional content. As a result, the set-top box module 700 receives the comment, shown as Step 704.

The set-top box module 700 sends the comment over the distribution network 202 and the comment is directed to the provider's mashup management system 206, shown as Step 705. MPEG data is generated for the mashup that includes the comment and the data is streamed to the subscriber's set-top box 201a, 201b (as well as to other subscribers' set-top boxes 201a, 201b viewing the mashup). The set-top box module 700 receives the MPEG data and generates signals to display the mashup on the subscriber's television (Steps 702 and 703). As a result, the mashup is now displayed with the subscriber's comment shown on the mashup.

Further, in particular embodiments, the subscriber may wish to view additional content associated with particular content shown on the mashup. For instance, returning to the example in which the mashup includes the current headlines from the CNN® website, the subscriber may wish to read a news article associated with one of the headlines listed on the mashup. In various embodiments, the subscriber indicates to view the additional content for the item through some mechanism, such as the subscriber's remote control, a keyboard in communication with the set-top box 201a, 201b, and/or an on-screen keyboard, and sends a request to the set-top box module 700 for the additional content.

In Step 706, the set-top box module 700 receives the selection of additional content for the particular content item. In Step 707, the set-top box module 700 sends the request to the mashup management system 206. In various embodiments, the request may include such information as a unique identifier that identifies the subscriber and/or set-top box. This identifier may have been provided along with the original MPEG data that was received to provide the mashup or may have been stored locally on the set-top box 201a, 201b. The request may also include an identifier that identifies the particular mashup and/or particular item on the mashup.

Thus, the request is routed over the provider's cable distribution network 202 to the mashup management system 206. In various embodiments, the mashup module 600 residing on the mashup management system 206 receives the request and processes the request by accessing the data source associated with the particular headline to obtain the content for the article. In particular embodiments, the content for the article may be an amount of content that will fit on the subscriber's television screen. For instance, in one embodiment, the mashup module 600 provides an amount of content that fits on a reader pane template that is configured according to a television screen. For instance, in various embodiments, the request received for the page of content may include an identifier of the television screen size. While in other embodiments, the subscriber's set-top box 201a, 201b may store the appropriate reader pane template and the set-top box module 700 may configure the content according to the template. The mashup module 600 converts the content for the article into MPEG data and has the data transmitted in the MPEG stream to the subscriber's set-top box 201a, 201b.

In Step 708, the set-top box module 700 receives the data and generates a signal from the data to display the content for the article to the subscriber, shown as Step 709. Thus, in the example, the subscriber is provided with the first page of the news article associated with the headline selected by the subscriber. The subscriber reads the page of the article and decides what action he would like to take next with regard to the news article. For instance, the subscriber may wish to read the next page of the article or may wish to exit the page and return to the mashup.

Therefore, in Step 710, the set-top box module 700 receives a selection of an option from the subscriber. As previously described, the subscriber may enter his choice of option through various mechanisms, such as a remote control, a keyboard in communication with the set-top box 201a, 201b, and/or an on-screen keyboard. As a result of receiving the subscriber's selection of an option, the set-top box module 700 determines which option the subscriber has selected.

In the particular embodiment of the set-top box module 700 shown in FIG. 7, the module 700 first determines whether the subscriber has selected the “exit” option, shown as Step 711. In this particular embodiment, the “exit” option is configured to return the subscriber out of the mashup to the menus on the set-top box 201a, 201b the subscriber used to request the mashup. For example, the subscriber's set-top box 201a, 201b may be configured so that the subscriber requests a mashup through the VOD service provided on the set-top box 201a, 201b. Thus, in this case, the subscriber is returned to the VOD menus upon exiting the mashup. Therefore, if the set-top box module 700 determines the subscriber has selected the “exit” option, the module 700 returns the subscriber to the set-top box menus, shown as Step 715.

If the set-top box module 700 determines the subscriber has not selected the “exit” option, the set-top box next determines whether the subscriber has selected the “top” option, shown as Step 712. In this particular embodiment, the “top” option is configured to return the subscriber to the mashup. Thus, if the set-top box module 700 determines the subscriber has selected the “top” option, the module 700 returns to Step 703 and generates signals for the mashup from the data received after the subscriber had made the original request for the mashup (along with any content that may have been posted by subscribers while viewing the mashup). In one particular embodiment, the data is cached in memory in the set-top box 201a, 201b so that it may be retrieved without having to send another request to the mashup management system 206. In another embodiment, the set-top box module 700 re-requests the data from the mashup management system 206. In turn, the subscriber is provided with the mashup on his television screen. At this point, in various embodiments, the subscriber may select another item displayed on the mashup to request additional content for or the subscriber may exit the mashup and return to the set-top box menus.

Returning to FIG. 7, if the set-top box module 700 determines that the subscriber has not selected the “top” option, the module 700 determines whether the subscriber has selected the “next” option, shown as Step 713. In this particular embodiment, the “next” option is configured to request additional content (e.g., “next page of content”) for the particular content (e.g., for the news article). If the set-top box module 700 determines the subscriber has selected this option, the set-top box module 700 returns to Step 707 and sends a request to the mashup management system 206 for the additional content (e.g., next page of the article). Thus, the mashup management system 206 receives the request and sends the set-top box module 700 a MPEG data for the additional content. In response, the set-top box module 700 receives the data, and generates signals to display the additional content to the subscriber.

Furthermore, if the set-top box module 700 determines that the subscriber has not selected the “next” option, the module 700 determines whether the subscriber has selected the “previous” option, shown as Step 714. In this particular embodiment, the “previous” option is configured to request previously retrieved content (e.g., “previous page of content”) for the particular content. If the set-top box module 700 determines the subscriber has selected this option, the module 700 also returns to Step 707 and sends a request to the mashup management system 206 for the previous content. As a result, the set-top box module 700 receives MPEG data from the mashup management system 206 and generates signals from the data to display the previous content to the subscriber.

If the set-top box module 700 determines that the subscriber has not selected the “next” option, the module 700 returns to Step 710 to receive a valid selection of an option from the subscriber. In various embodiments, the module 700 may also display a message to the subscriber informing him that the entered option was not valid.

Thus, the set-top box module 700 allows the subscriber to view the mashup, post content to the mashup, and to request additional content related to items displayed on the mashup. In addition, it should be appreciated by one of ordinary skill in the art that the options the subscriber may select from may be evaluated by the set-top box module 700 in other orders besides the order depicted in FIG. 7 according to various embodiments. The order shown in FIG. 7 is provided for illustrative purposes only and should not be construed to limit the scope of the claimed invention.

Further, in various embodiments, the set-top box module 700 may be configured to notify the subscriber of updated content on a particular mashup. Thus, the set-top box module 700 may receive MPEG data from the mashup module 600 that indicates content on a particular mashup has been updated. In response, the set-top box module 700 detects the status updates from the data and generates signals to display on the subscriber's television screen notifying the subscriber of the updates. In another example, a ticker may have a message that runs across the programming on the subscriber's television notifying the subscriber of the updated content.

### Exemplary Example of a Social Mashup

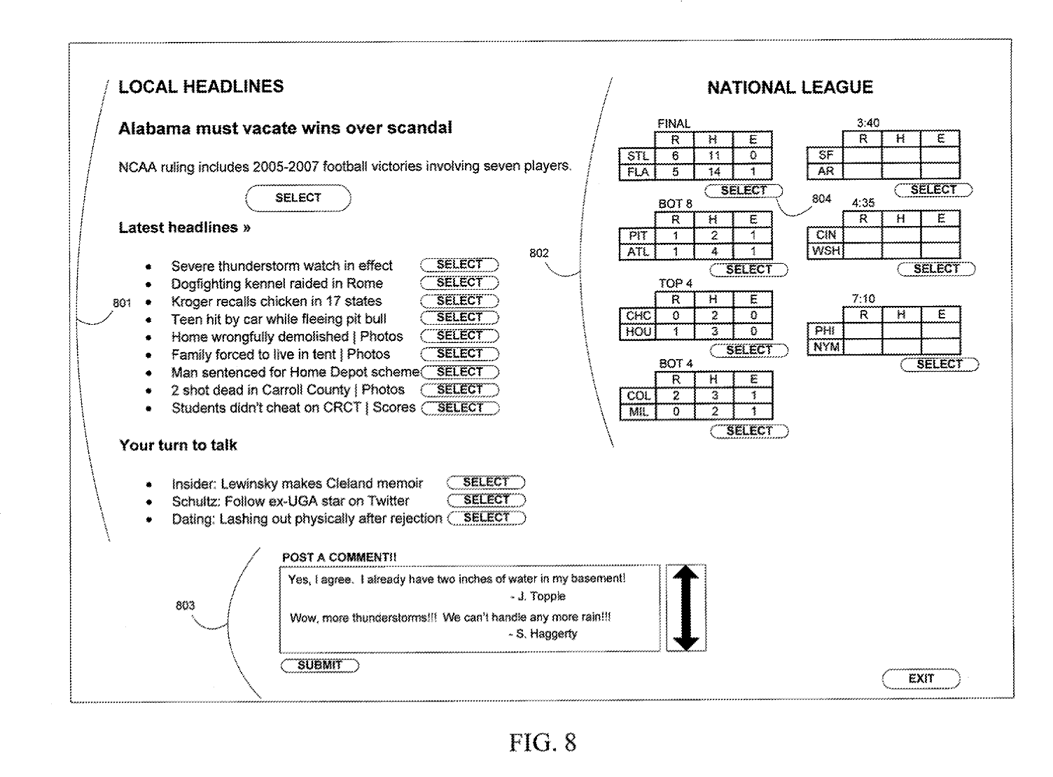

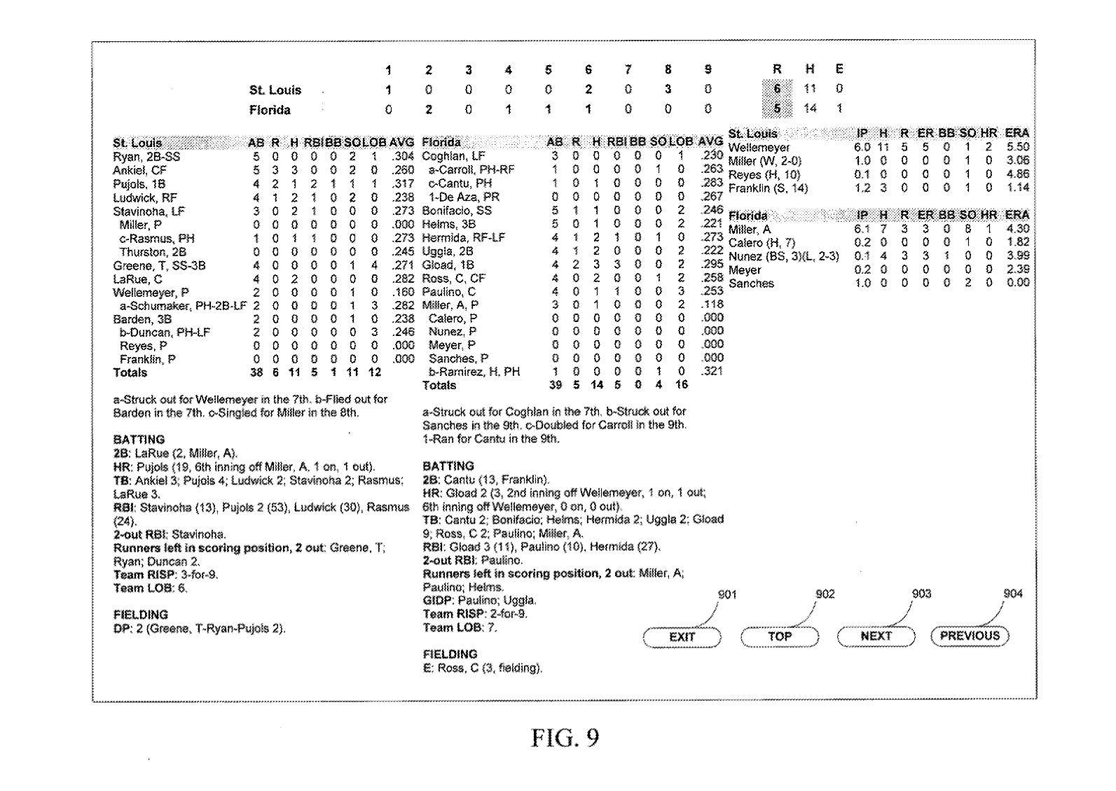

FIGS. 8 and 9 provide an example of a publisher's mashup according to various embodiments. As previously described, a publisher first configures the mashup and indicates what widgets and content to include on the mashup. In this particular example, the publisher selects a template and first selects a widget for the upper left partition of the template and defines the local news headlines in Atlanta to be the data source for the widget. For instance, the configuration tool may provide a listing of data sources for local news headlines and the publisher may select a particular data source from the listing, such as the website for the Atlanta Journal Constitution®.

The publisher continues to configure the mashup and selects a widget to display major league baseball scores from the national league. Similar to the first widget, the publisher selects (or enters) the data source for the widget, such as the official website for Major League Baseball®, and selects the location for the widget, e.g., the upper right partition of the template. Finally, the publisher selects a widget that is configured to allow subscribers viewing the mashup to post a comment on the mashup. In this example, the widget is configured as a text box that a subscriber can select and type in a comment and then select a “submit” button to post the comment.

As previously discussed, the mashup's configuration is saved and used to construct the mashup upon request. Once the publisher has configured the mashup, the publisher can publish the mashup so that it may be viewed by various subscribers. For example, the publisher may publish the mashup so that it is available to all the subscribers for the cable provider. Thus, a subscriber selects the mashup option listed in the VOD service provided by the subscriber's cable provider and selects the particular mashup configured by the publisher. In response, a request is sent for the mashup, content for the various widgets is retrieved, the mashup is generated (e.g., as MPEG data) on cable provider's system architecture 200, and the mashup is sent (e.g., in an MPEG stream) to the subscriber's set-top box 201a, 201b. In turn, the set-top box 201a, 201b generates signals and displays the mashup on the subscriber's television screen.

As can be seen in FIG. 8, the mashup displays the local headlines 801 in the upper left corner (e.g., partition) of the mashup, the national league baseball scores 802 in the upper right corner of the mashup, and the text box for posting comments 803 in the bottom half of the mashup. In addition, the mashup provides “SELECT” buttons for particular content. Thus, the subscriber can use his remote control to tab through the “SELECT” buttons to desired content if he would like to see additional content for any particular item.

For instance, the subscriber may be interested in seeing the box score for the St. Louis/Florida baseball game. Therefore, the subscriber tabs through the “SELECT” buttons using his remote control until the “SELECT” button 804 for the game is highlighted and the subscriber selects the “ENTER” button on his remote control.

A request is sent to the mashup management system 206 to provide the additional content for the box score. The mashup management system 206 retrieves the content for the box score and streams the content to the subscriber's set-top box 201a, 201b. The set-top box 201a, 201b generates signals from the streamed content and displays the box score on the subscriber's television screen. As previously discussed, in various embodiments, the set-top box 201a, 201b may receive the content already formatted and the set-top box 201a, 201b simply generates the signals to display the box score. In other embodiments, the set-top box 201a, 201b may first construct the box score page to display on the television screen from a reader pane template that is stored locally on the set-top box 201a, 201b.

Thus, the box score is displayed on the subscriber's television screen as shown in FIG. 9. The subscriber may read the information on the box score and may select one of four choices provided on the screen. First, the subscriber may exit the mashup by selecting the “EXIT” button 901. Second, the subscriber may return to the mashup by selecting the “TOP” button 902. Third, the subscriber may request the next page of information for the box score by selecting the “NEXT” button 903. Fourth, the subscriber may request the previous page of information for the box score by selecting the “PREVIOUS” button 904. (Note that in various embodiments all four buttons may not be provided on each page depending on whether there is a next page and/or previous page of content for the particular content.) Therefore, the subscriber can select any one of these four choices by tabbing through the four buttons via the subscriber's remote control. If the subscriber returns to the mashup, the subscriber may then select content for another item on the mashup to view further content.

Returning to FIG. 8, the mashup further includes a widget that allows subscribers to post comments. For instance, the mashup displays two comments that have been posted. The first comment is “[w]ow, more thunderstorms!!! We can't handle any more rain!!!” In addition, the mashup shows that subscriber S. Haggerty posted the comment. Thus, as a result of S. Haggerty posting the comment, the comment appears on the mashup for other subscribers to view. Further, in response to S. Haggerty's comment, another comment was posted by J. Topple. This comment reads “[y]es I agree. I already have two inches of water in my basement!”. Thus, as a result of the widget, subscribers can post comments on the mashup and interactive with each other.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for providing a mashup in a cable distribution system comprising:
a cable distribution network;
one or more servers in communication with the cable distribution network and configured to:
(a) receive a configuration for the mashup, the configuration comprising:
(1) a unique identifier identifying the mashup;
(2) a first display area associated with a data source; and
(3) a second display area identified for displaying text messages;
(b) store the configuration in memory;
(c) obtain content from the data source;
(d) receive a first request entered by a first subscriber for the mashup, the first request received over the cable distribution network from a first set-top box;
(e) in response to receiving the first request:
(1) obtain the configuration from the memory using the unique identifier;
(2) generate first MPEG data, the first MPEG data representing at least a portion of the content displayed in the first display area; and
(3) transmit the first MPEG data in a MPEG stream over the cable distribution network to the first set-top box, wherein the first set-top box generates signals from the first MPEG data to display the mashup with the portion of the content displayed in the first display area;
(f) receive a first text message originating from the first subscriber; and
(g) in response to receiving the first text message:
(1) generate second MPEG data, the second MPEG data representing the portion of the content displayed in the first display area and at least a portion of the first text message displayed in the second display area; and
(2) transmit the second MPEG data in the MPEG stream over the cable distribution network to the first set-top box, wherein the first set-top box generates signals from the second MPEG data to display the mashup with the portion of the content displayed in the first display area and the portion of the first text message displayed in the second display area.

2. The system of claim 1, wherein, in response to receiving a second request from a second subscriber for the mashup over the cable distribution network from a second set-top box, the one or more servers are configured to transmit the second MPEG data in a second MPEG stream over the cable distribution network to the second set-top box, and the second set-top box generates signals from the second MPEG data to display the mashup with the portion of the content displayed in the first display area and the portion of the first text message displayed in the second display area.

3. The system of claim 2, wherein, in response to receiving a second text message originating from the second subscriber, the one or more servers are configured to:
(1) generate third MPEG data, the third MPEG data representing the portion of the content displayed in the first display area and at least a portion of the first text message and at least a portion of the second text message displayed in the second display area; and
(2) transmit the third MPEG data in the MPEG stream and the second MPEG stream over the cable distribution network to the first set-top box and the second set-top box, respectively, wherein the first and second set-top boxes, generate signals from the third MPEG data to display the mashup with the portion of the content displayed in the first display area and the portion of the first text message and the portion of the second text message displayed in the second display area.

4. The system of claim 1, wherein the one or more servers receive the first text message over the cable distribution network from the first set-top box.

5. The system of claim 1, wherein the first text message is received by the one or more servers over a communication channel from a mobile device.

6. The system of claim 1, wherein the first text message is received by the one or more servers over a second network from a computer.

7. A system for providing a mashup in a cable distribution system comprising:
a cable distribution network;
one or more servers in communication with the cable distribution network and configured to:
(a) receive a configuration for the mashup, the configuration comprising:
(1) a unique identifier identifying the mashup;
(2) a first display area associated with a data source; and
(3) a second display area identified for displaying content;
(b) store the configuration in memory;
(c) obtain a first content from the data source;
(d) receive a first request entered by a first subscriber for the mashup, the first request received over the cable distribution network from a first set-top box;
(e) in response to receiving the first request:
(1) obtain the configuration from the memory using the unique identifier;
(2) generate first MPEG data, the first MPEG data representing at least a portion of the first content displayed in the first display area; and
(3) transmit the first MPEG data in a MPEG stream over the cable distribution network to the first set-top box, wherein the first set-top box generates signals from the first MPEG data to display the mashup with the portion of the first content displayed in the first display area;
(f) receive a content identifier originating from the first subscriber, the content identifier identifying a location of a second content; and
(g) in response to receiving the content identifier:
(1) retrieve the second content from the location using the content identifier;
(2) generate second MPEG data, the second MPEG data representing the portion of the first content displayed in the first display area and at least a portion of the second content displayed in the second display area; and
(3) transmit the second MPEG data in the MPEG stream over the cable distribution network to the first set-top box, wherein the first set-top box generates signals from the second MPEG data to display the mashup with the portion of the first content displayed in the first display area and the portion of the second content displayed in the second display area.

8. The system of claim 1, wherein, in response to receiving a second request from a second subscriber for the mashup over the cable distribution network from a second set-top box, the one or more servers are configured to transmit the second MPEG data in a second MPEG stream over the cable distribution network to the second set-top box, and the second set-top box generates signals from the second MPEG data to display the mashup with the portion of the first content displayed in the first display area and the portion of the second content displayed in the second display area.

9. The system of claim 1, wherein the second content comprises a video, an image, or audio.

10. A method for providing a mashup in a cable distribution system, the method comprising the steps of:
(a) receiving a configuration for the mashup, the configuration comprising:
(1) a unique identifier identifying the mashup;
(2) a first display area associated with a data source; and
(3) a second display area identified for displaying text messages;
(b) storing the configuration in memory;
(c) obtaining content from the data source by at least one computing device comprising at least one processor;
(d) receiving a first request entered by a first subscriber for the mashup, the first request received over a cable distribution network from a first set-top box;
(e) in response to receiving the first request:
(1) obtaining the configuration from the memory by the at least one processor using the unique identifier;
(2) generating first MPEG data by the at least one processor, the first MPEG data representing at least a portion of the content displayed in the first display area; and
(3) transmitting the first MPEG data in a MPEG stream over the cable distribution network to the first set-top box, wherein the first set-top box generates signals from the first MPEG data to display the mashup with the portion of the content displayed in the first display area;
(f) receiving a first text message originating from the first subscriber; and
(g) in response to receiving the first text message:
(1) generating second MPEG data by the at least one processor, the second MPEG data representing the portion of the content displayed in the first display area and at least a portion of the first text message displayed in the second display area; and
(2) transmitting the second MPEG data in the MPEG stream over the cable distribution network to the first set-top box, wherein the first set-top box generates signals from the second MPEG data to display the mashup with the portion of the content displayed in the first display area and the portion of the first text message displayed in the second display area.

11. The method of claim 10 further comprising the step of, in response to receiving a second request from a second subscriber for the mashup over the cable distribution network from a second set-top box, transmitting the second MPEG data in a second MPEG stream over the cable distribution network to the second set-top box, wherein the second set-top box generates signals from the second MPEG data to display the mashup with the portion of the content displayed in the first display area and the portion of the first text message displayed in the second display area.

12. The method of claim 11 further comprising, in response to receiving a second text message originating from the second subscriber, the steps of:
(1) generating third MPEG data by the at least one processor, the third MPEG data representing the portion of the content displayed in the first display area and at least a portion of the first text message and at least a portion of the second text message displayed in the second display area; and
(2) transmitting the third MPEG data in the MPEG stream and the second MPEG stream over the cable distribution network to the set-top box and the second set-top box, respectively, wherein the first and second set-top boxes generate signals from the third MPEG data to display the mashup with the portion of the content displayed in the first display area and the portion of the first text message and the portion of the second text message displayed in the second display area.

13. The method of claim 10, wherein the first text message is received over the cable distribution network from the first set-top box.

14. The method of claim 10, wherein the first text message is received over a communication channel from a mobile device.

15. The method of claim 10, wherein the first text message is received over a second network from a computer.

16. A method for providing a mashup in a cable distribution system, the method comprising the steps of:
(a) receiving a configuration for the mashup, the configuration comprising:
(1) a unique identifier identifying the mashup;
(2) a first display area associated with a data source; and
(3) a second display area identified for displaying content;
(b) storing the configuration in memory;
(c) obtaining a first content from the data source;
(d) receiving a first request entered by a first subscriber for the mashup, the first request received over the cable distribution network from a first set-top box;
(e) in response to receiving the first request:
(1) obtaining the configuration from the memory using the unique identifier;
(2) generating first MPEG data, the first MPEG data representing at least a portion of the first content displayed in the first display area; and
(3) transmitting the first MPEG data in a MPEG stream over the cable distribution network to the first set-top box, wherein the first set-top box generates signals from the first MPEG data to display the mashup with the portion of the first content displayed in the first display area;
(f) receiving a content identifier originating from the first subscriber, the content identifier identifying a location of a second content; and
(g) in response to receiving the content identifier:
(1) retrieving the second content from the location using the content identifier;
(2) generating second MPEG data, the second MPEG data representing the portion of the first content displayed in the first display area and at least a portion of the second content displayed in the second display area; and
(3) transmitting the second MPEG data in the MPEG stream over the cable distribution network to the first set-top box, wherein the first set-top box generates signals from the second MPEG data to display the mashup with the portion of the first content displayed in the first display area and the portion of the second content displayed in the second display area.

17. The method of claim 16 further comprising, in response to receiving a second request from a second subscriber for the mashup over the cable distribution network from a second set-top box, the step of transmitting the second MPEG data in a second MPEG stream over the cable distribution network to the second set-top box, wherein the second set-top box generates signals from the second MPEG data to display the mashup with the portion of the first content displayed in the first display area and the portion of the second content displayed in the second display area.

18. The method of claim 16, wherein the second content comprises a video, an image, or audio.

19. A system for providing a mashup in a cable distribution system comprising:
a cable distribution network;
one or more servers in communication with the cable distribution network and configured to:
(a) receive a configuration for the mashup, the configuration comprising:
(1) a unique identifier identifying the mashup; and
(2) a display area associated with a data source and identified for displaying content;
(b) store the configuration in memory;
(c) obtain a first content from the data source;
(d) receive a first request entered by a subscriber for the mashup, the first request received over the cable distribution network from a set-top box;
(e) in response to receiving the first request:
(1) obtain the configuration from the memory using the unique identifier;
(2) generate first MPEG data, the first MPEG data representing at least a portion of the first content displayed in the display area; and
(3) transmit the first MPEG data in a MPEG stream over the cable distribution network to the set-top box, wherein the set-top box generates signals from the first MPEG data to display the mashup with the portion of the first content displayed in the display area;
(f) receive a content identifier originating from the subscriber, the content identifier identifying a location of a second content; and
(g) in response to receiving the content identifier:
(1) retrieve the second content from the location using the content identifier;
(2) generate second MPEG data, the second MPEG data representing the portion of the first content displayed in the display area and at least a portion of the second content displayed in the display area; and
(3) transmit the second MPEG data in the MPEG stream over the cable distribution network to the set-top box, wherein the set-top box generates signals from the second MPEG data to display the mashup with the portion of the first content displayed and the portion of the second content displayed in the display area.

20. The system of claim 19, wherein the second content comprises a video, an image, or audio.
